(19) United States
(12) Patent Application Publication
(10) Pub. No.: US 2024/0240984 A1
(43) Pub. Date: Jul. 18, 2024

(54) LIGHT DETECTION DEVICE

(71) Applicant: SONY SEMICONDUCTOR SOLUTIONS CORPORATION, KANAGAWA (JP)

(72) Inventors: HIDEKAZU KIKUCHI, KANAGAWA (JP); TAKAFUMI TAKATSUKA, KANAGAWA (JP)

(21) Appl. No.: 18/561,786

(22) PCT Filed: Mar. 1, 2022
(86) PCT No.: PCT/JP2022/008480

§ 371 Date: Nov. 17, 2023

(30) Foreign Application Priority Data
Jun. 8, 2021 (JP) 2021-096157

(51) Int. Cl. G01J 1/44; H04N 25/709; H04N 25/78

(52) U.S. Cl. CPC G01J 1/44; H04N 25/709; H04N 25/78; G01J 2001/442; G01J 2001/4466

(57) ABSTRACT

Provided is a light detection device capable of accurately measuring a signal voltage from a diode that detects light. A light detection device according to the present disclosure includes: first diodes that receive light and output a signal voltage; a digital-to-analog converter that outputs a reference voltage in synchronization with a clock signal; a comparison circuit that compares the signal voltage with the reference voltage; a trigger circuit that outputs a trigger signal in response to the signal voltage; a flip-flop that takes an output signal from the comparison circuit in response to the trigger signal; and a first counter that outputs a digital value that changes in accordance with an average voltage at feature points of the signal voltage by counting a value of an output signal from the flip-flop in synchronization with the clock signal.

### TECHNICAL FIELD

The present disclosure relates to a light detection device.

### BACKGROUND ART

As a diode for detecting light, a single photon avalanche diode (SPAD) has attracted attention. The SPAD causes avalanche amplification once a PN junction receives light of one photon in a state where a voltage that is higher than a breakdown voltage is applied (Geiger mode). As a result, a current instantaneously flows through the SPAD, and light (photon) can be detected. The SPAD is used as a photoelectric conversion of each pixel of a distance measurement device, for example.

### CITATION LIST

### Patent Literature

### [PTL 1]

JP 2021-56016A

### [PTL 2]

JP 2015-41746A

### SUMMARY

### Technical Problem

FIG. 15A is a circuit diagram illustrating a configuration of a certain light detection device.

The light detection device includes a plurality of light detection units 1, an inter-pixel average acquisition unit 2, a time average acquisition unit 3, and an analog-to-digital converter (ADC) 4. Each light detection unit 1 includes a timing detection circuit 1a, a buffer 1b, a sample hold circuit 1c, a monitoring SPAD 11, and a recharge transistor 12. The light detection device can control SPAD bias of the monitoring SPAD 11 by measuring a quench voltage of the monitoring SPAD 11.

In each light detection unit 1, a cathode of the monitoring SPAD 11 is intermittently recharged by the recharge transistor 12, and incidence of a photon is waited for. Once a photon is incident on the monitoring SPAD 11, and avalanche breakdown occurs, a cathode voltage Vk of the monitoring SPAD 11 suddenly drops, reaches the quench voltage, and stands still.

The sudden drop of the voltage is detected by the timing detection circuit 1a. As a result, a trigger pulse (trigger signal) TRG occurs from the timing detection circuit 1a after an appropriate delay and the trigger pulse TRG continues for an appropriate period of time. The sample hold circuit 1c takes the quench voltage via the buffer 1b during the period of time during which the trigger pulse TRG continues.

The quench voltage varies depending on individual monitoring SPADs 11. Also, the quench voltage changes every time avalanche breakdown occurs even in the same individual monitoring SPAD 11. In order to control bias to be given to the monitoring SPAD 11, it is necessary to cause avalanche breakdown a large number of times by a large number of monitoring SPADs 11 and to obtain an average value of a large number of quench voltages generated by this.

Therefore, the light detection device in FIG. 15A includes the inter-pixel average acquisition unit 2, the time average acquisition unit 3, and the ADC 4. These quench voltages are averaged among the pixels (among the light detection units 1) by the inter-pixel average acquisition unit 2, are averaged in a specific period of time by the time average acquisition unit 3, and are converted into a digital value by the ADC 4.

FIG. 15B is a timing chart illustrating operations of the light detection device in FIG. 15A.

FIG. 15B illustrates a timing at which a photon is incident on a certain monitoring SPAD 11, a cathode voltage Vk from the monitoring SPAD 11, a trigger signal TRG from the timing detection circuit 1a, a control signal XRCG to the gate of the recharge transistor 12, and an output signal Vsh from the sample hold circuit 1c.

The time interval between photons that are incident on each monitoring SPAD 11 is random. Also, there is a high likelihood that the time interval becomes long in a case where the incident light has low illuminance. If no photons are incident on the monitoring SPAD 11, and avalanche breakdown does not occur, the trigger pulse TRG does not occur, and the sample hold circuit 1c continues to hold the quench voltage finally taken.

However, voltage information stored in the capacitance of the sample hold circuit 1c has a lifetime, and the storage voltage held for a long period of time diverges from the taken quench voltage. There is thus a problem that it is not possible to accurately measure the quench voltage in the case where the incident light has low luminance and it is also not possible to control SPAD bias on the basis of the quench voltage information.

Thus, the present disclosure provides a light detection device capable of accurately measuring a signal voltage from a diode that detects light.

### Solution to Problem

Alight detection device according to a first aspect of the present disclosure includes: first diodes that receive light and output a signal voltage; a digital-to-analog converter that outputs a reference voltage in synchronization with a clock signal; a comparison circuit that compares the signal voltage with the reference voltage; a trigger circuit that outputs a trigger signal in response to the signal voltage; a flip-flop that takes an output signal from the comparison circuit in response to the trigger signal; and a first counter that outputs a digital value that changes in accordance with an average voltage at feature points of the signal voltage by counting a value of an output signal from the flip-flop in synchronization with the clock signal. It is thus possible to accurately measure the average voltage by maintaining a measurement result for calculating the average voltage as a digital value for a long period of time, for example.

In the first aspect, the first counter may output the digital value that changes in accordance with the average voltage at the feature points of the signal voltage by incrementing a count value in a case where a value of the output signal from the flip-flop is 1 at an edge of the clock signal. It is thus possible to cause the first counter to operate to output, as the digital value, a value that changes in accordance with the average voltage, for example.

In the first aspect, the feature points of the signal voltage may be avalanche quenches of the signal voltage, and the first counter may output the digital value that changes in accordance with an average value of quench voltages of the signal voltage. It is thus possible to appropriately measure the average value of the quench voltages in a case where the avalanche is a detection target, for example.

In the first aspect, the first diodes may be single photon avalanche diodes (SPADs). It is thus possible to accurately measure the average voltage for SPADs that may cause a problem when a time interval between photons is long, for example.

In the first aspect, the digital-to-analog converter may sweep the reference voltage by increasing the reference voltage in a stepwise manner. It is thus possible to accurately measure the average voltage even if the voltages at the feature points of the signal voltage significantly change, for example.

In the first aspect, the trigger circuit may include a pulse detection circuit including an inverter that receives the signal voltage and a delay circuit that generates the trigger signal by delaying an output signal from the pulse detection circuit. It is thus possible to accurately measure the average voltage with an appropriate trigger signal, for example.

Also, the light detection device according to the first aspect may further include: a recharge transistor that is electrically connected to the first diodes, the comparison circuit, and the trigger circuit; and a second counter that controls the digital-to-analog converter in synchronization with the clock signal. It is thus possible to appropriately recharge and control the diodes, for example.

The light detection device according to the first aspect may further include: a third counter that counts the number of clock cycles at which the feature points of the signal voltage are detected; and an arithmetic operation circuit that calculates the average voltage at the feature points of the signal voltage by using the digital value and the number of clock cycles. It is thus possible to accurately calculate the average voltage by using the count value (the number of clock cycles) of the third counter in calculation of the average voltage, for example.

In the first aspect, the comparison circuit may include a first source follower that receives the signal voltage, a second source follower that receives the reference voltage, and a comparator that compares an output voltage from the first source follower with an output voltage from the second source follower. It is thus possible to accurately measure the average voltage by reducing shift of the signal voltage due to kickback, for example.

The light detection device according to the first aspect may further include: a feedback circuit that feedbacks a signal generated in accordance with the digital value to the first diodes. It is thus possible to improve image quality in a case where the light detection device is used for image capturing, for example.

The light detection device according to the first aspect may further include: a correction circuit that performs photon detection efficiency (PDE) correction in accordance with the digital value. It is thus possible to improve image quality in a case where the light detection device is used for image capturing, for example.

In the first aspect, the digital-to-analog converter may sweep the reference voltage by increasing the reference voltage in a stepwise manner at a proportion of once a plurality of clock cycles. It is thus possible to accurately measure the average voltage even in a case where a digital-to-analog converter with a small number of gradations is used, for example.

In the first aspect, the digital-to-analog converter may sweep the reference voltage by increasing and decreasing the reference voltage in a stepwise manner. It is thus possible to improve robustness in relation to measurement of the average voltage, for example.

In the first aspect, the digital-to-analog converter may update a value of the reference voltage by a pseudo random number that changes in synchronization with the clock signal. It is thus possible to improve robustness in relation to measurement of the average voltage, for example.

The light detection device according to the first aspect may further include: second diodes that are provided in a semiconductor substrate including the first diodes and are used for image capturing. It is thus possible to manufacture the first and second diodes in the same process, for example.

In the first aspect, the first diodes may be disposed at positions separated from a pixel array including the second diodes by one pixel pitch or more. It is thus possible to easily dispose a light blocking wall between the first diodes and the second diodes, for example.

The light detection device according to the first aspect may further include: a first substrate including the first diodes; and a second substrate that is attached to the first substrate. It is thus possible to improve performance of the light detection device by forming the first diodes and the circuit for the first diodes on different substrates, for example.

In the first aspect, the signal voltage may be generated by the plurality of first diodes that are connected to each other in parallel. It is thus possible to more accurately measure the average voltage, for example.

In the first aspect, an active region of the first diodes may be larger than an active region of the second diodes used for image capturing. It is thus possible to accurately measure the signal voltage even with low illuminance, for example.

The light detection device according to the first aspect may further include: second diodes that have a dark count rate that is different from that of the first diodes and are used for image capturing. It is thus possible to accurately measure the average voltage even in a no-light state or a state that is close to the no-light state, for example.

The light detection device according to the first aspect may further include: a light blocking unit that blocks the first diodes from light directed to the first diodes. It is thus possible to accurately measure the average voltage even in a case where the second diodes having a different dark count rate from that of the first diodes are used.

In the first aspect, a reciprocal of a dark count rate of the first diodes may be set to be shorter than a delay until an output signal from the comparison circuit is taken in response to the trigger signal. It is thus possible to perform effective measurement to control bias of the diodes such that the worst signal voltage does not exceed an element breakdown voltage of a pixel circuit.

Alight detection device according to a second aspect of the present disclosure includes: first diodes that receive light and output a signal voltage; a digital-to-analog converter that outputs a reference voltage; a comparison circuit that compares the signal voltage with the reference voltage; a trigger circuit that outputs a trigger signal in response to the signal voltage; a flip-flop that takes an output signal from the comparison circuit in response to the trigger signal; and a state machine that outputs a signal to cause the digital-to-analog converter to update the reference voltage and outputs an average voltage at feature points of the signal voltage in response to an output signal from the flip-flop. It is thus possible to accurately measure the average voltage with the state machine in a short period of time, for example.

### BRIEF DESCRIPTION OF DRAWINGS

FIG. 1 is a circuit diagram illustrating a configuration of a light detection device according to a first embodiment.

FIG. 1B is a timing chart illustrating operations of the light detection device according to the first embodiment.

FIG. 1C is another timing chart illustrating operations of the light detection device according to the first embodiment.

FIG. 1D is a graph for explaining operations of the light detection device according to the first embodiment.

FIG. 2A is a circuit diagram illustrating a configuration of a light detection device according to a second embodiment.

FIG. 2B is a timing chart illustrating operations of the light detection device according to the second embodiment.

FIG. 3A is a circuit diagram illustrating a configuration of a comparison circuit according to a third embodiment.

FIG. 3B is a circuit diagram illustrating a configuration of a comparison circuit according to a comparative example of the third embodiment.

FIG. 3C is a timing chart illustrating operations of the comparison circuit according to the comparative example of the third embodiment.

FIG. 3D is a timing chart illustrating operations of the comparison circuit according to the third embodiment.

FIG. 3E is a graph for explaining operations of the comparison circuit according to the third embodiment.

FIG. 4 is a circuit diagram illustrating a configuration of a light detection device according to a fourth embodiment.

FIG. 5A is a circuit diagram illustrating a configuration of a light detection device according to a fifth embodiment.

FIG. 5B is a graph for explaining operations of the light detection device according to the fifth embodiment.

FIG. 6A is a timing chart illustrating operations of a light detection device according to a sixth embodiment.

FIG. 6B is a circuit diagram illustrating a configuration of the light detection device according to the sixth embodiment.

FIG. 7A is a timing chart illustrating operations of a light detection device according to a seventh embodiment.

FIG. 7B is a circuit diagram illustrating a configuration of a lamp counter according to the seventh embodiment.

FIG. 7C is a graph for explaining operations of the light detection device according to the seventh embodiment.

FIG. 8A is a circuit diagram illustrating a configuration of a light detection device according to an eighth embodiment.

FIG. 8B is a timing chart illustrating operations of the light detection device according to the eighth embodiment.

FIG. 8C is a flowchart illustrating operations of the light detection device according to the eighth embodiment.

FIG. 8D is a circuit diagram illustrating a configuration of a light detection device according to a modification example of the eighth embodiment.

FIG. 8E is a timing chart illustrating operations of the light detection device according to the modification example of the eighth embodiment.

FIG. 9 is a circuit diagram illustrating a configuration of a light detection device according to a ninth embodiment.

FIG. 10A is a circuit diagram illustrating a configuration of a light detection device according to a tenth embodiment.

FIG. 10B is a planar view illustrating a configuration of a light detection device according to a modification example of the tenth embodiment.

FIG. 10C is a planar view illustrating a configuration of a light detection device according to another modification example of the tenth embodiment.

FIG. 11 is a perspective view illustrating a configuration of a light detection device according to an eleventh embodiment.

FIG. 12A is a circuit diagram illustrating a configuration of a light detection device according to a twelfth embodiment.

FIG. 12B is a planar view illustrating a configuration of a light detection device according to a modification example of the twelfth embodiment.

FIG. 13A is a circuit diagram illustrating a configuration of a light detection device according to a thirteenth embodiment.

FIG. 13B is a timing chart illustrating operations of the light detection device according to the thirteenth embodiment.

FIG. 13C is a sectional view illustrating a structure of a monitoring SPAD according to the thirteenth embodiment.

FIG. 14A is a sectional view schematically illustrating a configuration of a light detection device according to a fourteenth embodiment.

FIG. 14B is a timing chart illustrating operations of the light detection device according to the fourteenth embodiment.

FIG. 14C is another timing chart illustrating operations of the light detection device according to the fourteenth embodiment.

FIG. 15A is a circuit diagram illustrating a configuration of a certain light detection device.

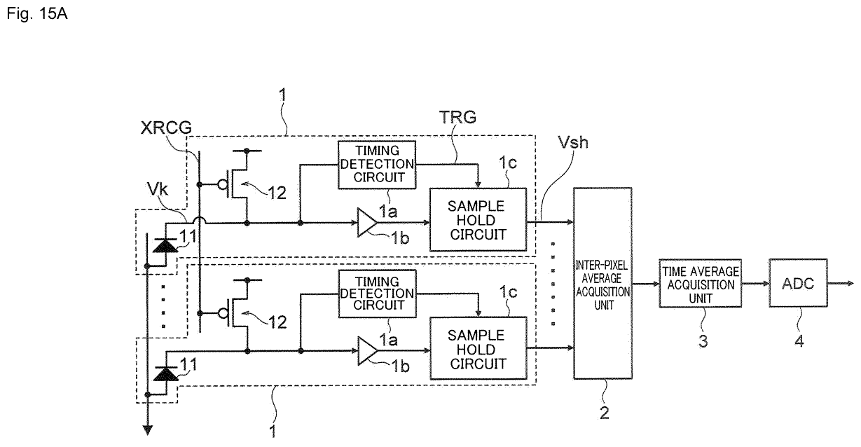

FIG. 15B is a timing chart illustrating operations of the light detection device in FIG. 15A.

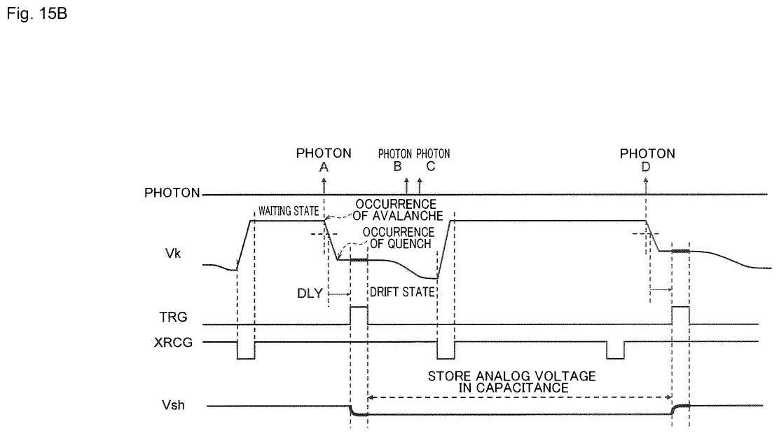

FIG. 16 is a block diagram showing a configuration example of an electronic device.

FIG. 17 is a block diagram showing a configuration example of a mobile control system.

FIG. 18 is a plan view showing a specific example of setting positions of imaging units in FIG. 17.

FIG. 19 is a diagram showing one example of a schematic configuration of an endoscopic surgery system.

FIG. 20 is a block diagram showing an example of a functional configuration of a camera head and a CCU.

### DESCRIPTION OF EMBODIMENTS

Hereinafter, embodiments of the present invention will be described with reference to the drawings.

### First Embodiment

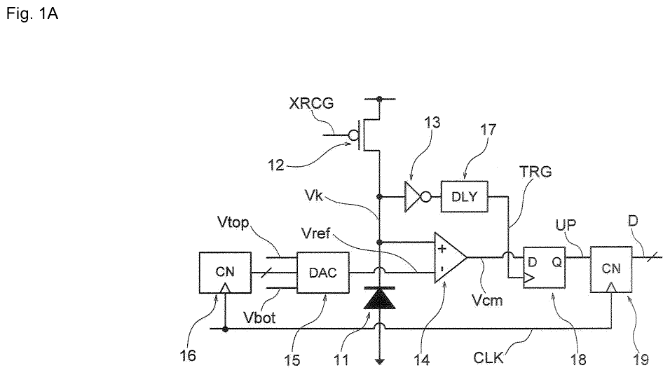

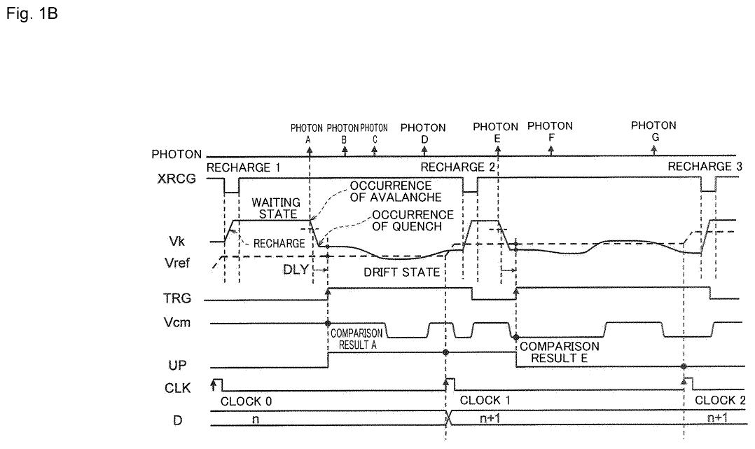

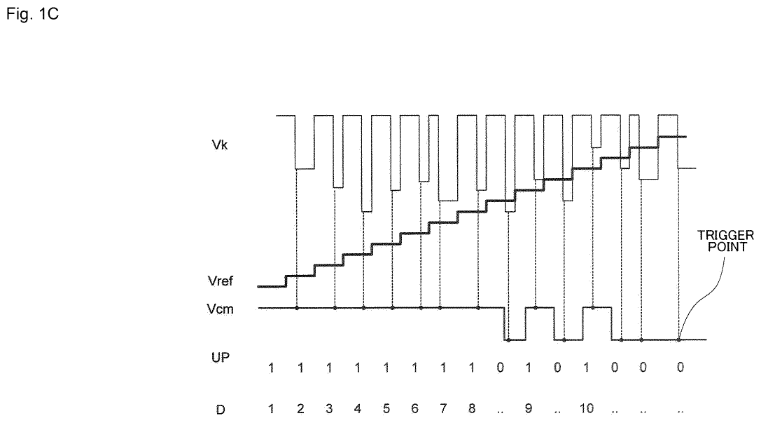

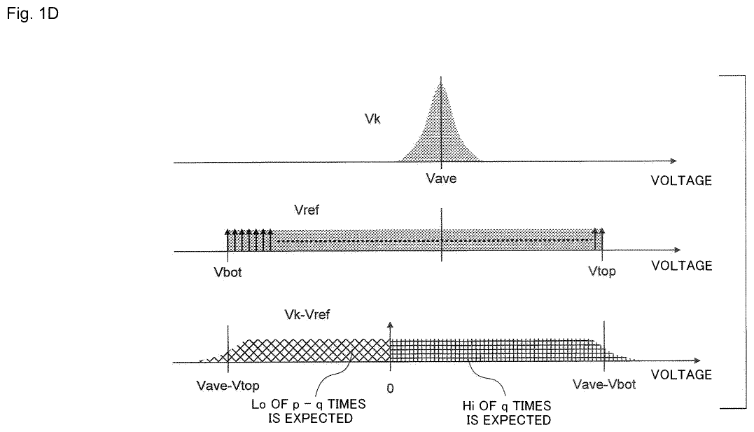

FIG. 1A is a circuit diagram illustrating a configuration of a light detection device according to a first embodiment.

The light detection device according to the present embodiment includes a monitoring SPAD 11, a recharge transistor 12, a pulse detection circuit 13, a comparison circuit 14, a digital-to-analog converter (DAC) 15, a lamp counter 16, a delay circuit 17, a flip-flop (D-FF) 18, and a comparison result counter 19. The monitoring SPAD 11 is an example of the first diode according to the present disclosure. The pulse detection circuit 13 and the delay circuit 17 are examples of the trigger circuit according to the present disclosure. The comparison result counter 19 is an example of the first counter according to the present disclosure. The lamp counter 16 is an example of the second counter according to the present disclosure. The light detection device according to the present embodiment functions as a quench voltage measurement means in a solid-state imaging device or a distance measurement device, for example.

The monitoring SPAD 11 has an anode that is electrically connected to a negative power source and a cathode that is electrically connected to a positive power source via the recharge transistor 12. The monitoring SPAD 11 receives light and outputs a cathode voltage Vk. The cathode voltage Vk is an example of the signal voltage according to the present disclosure.

The recharge transistor 12 has a gate to which a control signal XRCG is supplied. One of a source and a drain of the recharge transistor 12 is electrically connected to the positive power source, and the other one of the source and the drain of the recharge transistor 12 is electrically connected to the negative power source via the monitoring SPAD 11. The monitoring SPAD 11 and the recharge transistor 12 are connected in series between the positive power source and the negative power source. A cathode of the monitoring SPAD 11 is intermittently recharged by the recharge transistor 12.

The pulse detection circuit 13 includes an inverter, and the inverter has an input terminal that is electrically connected to the monitoring SPAD 11 and the recharge transistor 12 and an output terminal that is electrically connected to the delay circuit 17. The pulse detection circuit 13 receives the cathode voltage Vk at the input terminal and outputs an output signal in accordance with the cathode voltage Vk from the output terminal.

The comparison circuit 14 has a positive input terminal that is electrically connected to the monitoring SPAD 11 and the recharge transistor 12, a negative input terminal that is electrically connected to the DAC 15, and an output terminal that is electrically connected to the D-FF 18. The comparison circuit 14 receives the cathode voltage Vk at the positive input terminal, receives a reference voltage Vref from the DAC 15 at the negative input terminal, compares the cathode voltage Vk with the reference voltage Vref, and outputs a comparison result signal Vcm indicating the comparison result from the output terminal. The comparison circuit 14 may include only a comparator or may include a comparator and other circuit elements (for example, a source follower transistor).

The DAC 15 outputs the reference voltage Vref having any value from a maximum voltage Vtop to a minimum voltage Vbot to the comparison circuit 14 (Vbot≤Vref≤Vtop). The DAC 15 can sweep the reference voltage Vref between the maximum voltage Vtop and the minimum voltage Vbot.

The lamp counter 16 operates in synchronization with a clock signal CLK and outputs an output signal in accordance with the clock signal CLK to the DAC 15. Therefore, the DAC 15 outputs the reference voltage Vref in synchronization with the clock signal CLK. Also, the DAC 15 generates the reference voltage Vref by converting the output signal from the lamp counter 16 into an analog signal through DA conversion. As will be described later, the DAC 15 sweeps the reference voltage Vref by increasing the reference voltage Vref in a stepwise manner. In this manner, the DAC 15 is controlled by the lamp counter 16.

The delay circuit 17 delays an output signal from the pulse detection circuit 13 and generates a trigger signal TRG. The trigger signal TRG is input to the D-FF 18.

The D-FF 18 has a D terminal to which the comparison result signal Vcm is input, a CLK terminal to which the trigger signal TRG is input, and a Q terminal that outputs an FF output signal UP. The D-FF 18 takes the comparison result signal Vcm in response to the trigger signal TRG and outputs the FF output signal UP in accordance with the comparison result signal Vcm. The FF output signal UP signal is a binary signal indicating a value 0 (logic 0) or a value 1 (logic 1).

The comparison result counter 19 outputs a digital value that changes in accordance with the average voltage at feature points of the cathode voltage Vk by counting the value of the FF output signal UP in synchronization with the clock signal CLK. Specifically, the comparison result counter 19 outputs the digital value that changes in accordance with the average voltage at the feature points of the cathode voltage Vk by incrementing the count value in a case where the value of the FF output signal UP is 1 at an edge of the clock signal CLK. The comparison result counter 19 outputs a digital signal D indicating the digital value. The digital signal D can be used to calculate the average voltage at the feature points of the cathode voltage Vk from the digital value. In this manner, the comparison result counter 19 functions as an analog-to-digital converter (ADC) that converts a value that changes in accordance with the average voltage into a digital value through AD conversion.

The feature points of the cathode voltage Vk in the present embodiment are avalanche quenches of the cathode voltage Vk, for example. The comparison result counter 19 according to the present embodiment outputs a digital value that changes in accordance with the average value of the avalanche quench voltages of the cathode voltage Vk by counting the value of the FF output signal UP in synchronization with the clock signal CLK. Further details of the processing will be described later.

FIG. 1B is a timing chart illustrating operations of the light detection device according to the first embodiment.

A recharge pulse (control signal) XRCG is intermittently supplied to the gate of the recharge transistor 12. The cathode voltage Vk is raised to a positive power source voltage by the recharge pulse XRCG (the recharge 1, for example). The cathode voltage Vk waits in an excessive bias state in which a voltage that is equal to or greater than a breakdown voltage is applied between the anode and the cathode of the monitoring SPAD 11.

The monitoring SPAD 11 causes avalanche breakdown with the first photon (a photon A, for example) after the recharge, and the cathode voltage Vk suddenly drops. Then, quench occurs at the point when the monitoring SPAD 11 loses the excessive bias, and the cathode voltage Vk stands still with the quench voltage.

A pulse is detected by the pulse detection circuit 13 at a point when the cathode voltage Vk drops below a threshold value of the pulse detection circuit 13 in the process of dropping of the cathode voltage Vk. The output signal from the pulse detection circuit 13 is delayed by the delay circuit 17, and the trigger signal TRG is generated.

The comparison circuit 14 successively compares the cathode voltage Vk with the reference voltage Vref and outputs the comparison result signal Vcm indicating the comparison result. The delay amount DLY of the trigger signal TRG is adjusted to set a clock time of the edge of the trigger signal TRG to a clock time at which the result of comparing the quench voltage after occurrence of the quench with the reference voltage Vref is reflected to the comparison result signal Vcm. However, both the monitoring SPAD 11 and the recharge transistor 12 are in a Hi-Z state after the quench, the cathode voltage Vk diverges from the quench voltage due to drift caused by a leak current after elapse of a long period of time, and it is thus desirable not to set the delay amount DLY to be unnecessarily long.

The comparison result signal Vcm is taken by the D-FF 18 at the edge of the trigger signal TRG. For example, the quench voltage generated by the photon A is higher than the reference voltage Vref at that point, the comparison result A is thus 1, and the FF output signal UP taking the comparison result A is also 1.

The value of the digital signal D is incremented or held on the basis of the FF output signal UP at the clock edge (for example, the clock 1) of the clock signal CLK, and the reference voltage Vref is thereby updated. Since the FF output signal UP is 1 at the clock 1, for example, the value of the digital signal D is incremented. Once the update of the reference voltage Vref ends, recharge is performed again, and operations until this point are repeated.

FIG. 1C is another timing chart illustrating operations of the light detection device according to the first embodiment.

FIG. 1C is a timing chart of a longer span than that in FIG. 1B. The cathode voltage Vk in FIG. 1B is compared with the reference voltage Vref twice, while the cathode voltage Vk in FIG. 1C is compared with the reference voltage Vref fifteen times. A change in cathode voltage Vk in FIG. 1C is depicted in a more simplified manner than a change in cathode voltage Vk in FIG. 1B in order to facilitate easy viewing of the drawing.

In FIG. 1C, the reference voltage Vref is updated fourteen times, and as a result, the reference voltage Vref increases in a stepwise manner (in a step manner). The reference voltage Vref in the present embodiment is an increase function with respect to a time.

In FIG. 1C, the cathode voltage Vk (quench voltage) is greater than the reference voltage Vref at the time of the first to eighth, tenth, and twelfth comparison, and is smaller than the reference voltage Vref at the time of the ninth, eleventh, and thirteenth to fifteenth comparison. Therefore, the cathode voltage Vk (quench voltage) is greater than the reference voltage Vref only ten times out of the fifteen times, and the final value of the digital signal D is 10. At this time, the average value (average voltage) Vave of the quench voltages is estimated by Expression (1) below.

$$Vave = ( 5 / 15 ) Vbot + ( 10 / 15 ) Vtop \qquad ( 1 )$$

Note that the reference voltage Vref at the time of the first comparison is the minimum voltage Vbot, and the reference voltage Vref at the time of the fifteenth comparison is the maximum voltage Vtop. Also, the reference voltage Vref at the time of the N-th comparison in the present embodiment is ((15−N)/14)Vbot+((N−1)/14)Vtop (N is an integer that satisfies 1≤N≤15).

FIG. 1D is a graph for explaining operations of the light detection device according to the first embodiment. A method for estimating the average value Vave of the quench voltages from the digital value of the digital signal D will be described with reference to FIG. 1D.

The graph in the upper section in FIG. 1D illustrates distribution of the cathode voltage Vk sampled in accordance with the trigger signal TRG, that is, distribution of the quench voltages. The quench voltages fluctuate every time avalanche breakdown and quench are repeated even with the same monitoring SPAD 11. The distribution of the quench voltages typically approaches normal distribution with a standard deviation of 50 to 100 mV.

The graph in the middle section in FIG. 1D illustrates distribution of the reference voltage Vref. The reference voltage Vref in the present embodiment is uniformly swept from the voltage Vbot that is obviously lower than the quench voltages to the voltage Vtop that is obviously higher than the quench voltages.

Therefore, on the assumption that the average value of the quench voltages is Vave, a voltage difference Vk−Vref between the positive and negative input terminals of the comparison circuit 14 is substantially uniformly distributed from the negative side (Vave−Vtop to 0) to the positive side (0 to Vave−Vbot) as illustrated by the graph in the lower section in FIG. 1D. In a case where the number of times the comparison circuit 14 performs comparison is defined as “p”, and the expected value of the number of times the comparison circuit 14 determines that the voltage difference Vk−Vref is positive in that case is defined as “q”, Expression (2) below is established.

$$( p - q ) / ( Vtop - Vave ) = q / ( Vave - Vbot ) \qquad ( 2 )$$

Expression (3) below is obtained by modifying Expression (2).

$$Vave = ( ( p - q ) / p ) Vbot + ( q / p ) Vtop \qquad ( 3 )$$

Expression (3) is obtained by generalizing Expression (1). Expression (1) is obtained by substituting p=15 and q=10 to Expression (3).

Since p is a fixed value, the final value q of the digital value of the digital signal D is a value that determines the average value of the quench voltages. In other words, it is possible to calculate the average value of the quench voltages from q by the light detection device according to the present embodiment measuring q. Therefore, it is possible to state that q is a value corresponding to the average value of the quench voltages. The light detection device according to the present embodiment may include a circuit that calculates the average value of the quench voltages from the values Vbot, Vtop, p, and q on the basis of Expression (3), and the circuit may output the average value as a digital value.

The value of q in the present embodiment is generated by taking the comparison result signal Vcm immediately after the quench in the D-FF 18. Therefore, it is possible to accurately measure the average quench voltage (the average value of the quench voltages) and to output the average quench voltage as a digital value even if illuminance of light incident on the monitoring SPAD 11 is low and the pulse is sparse. On the other hand, the value of q is determined only by avalanche breakdown occurring for the first time after the recharge even in a case where the illuminance of the light incident on the monitoring SPAD 11 is high and photons arrive at close time intervals, and it is thus possible to accurately measure the average quench voltage.

As described above, the light detection device according to the present embodiment includes the comparison circuit 14 that compares the cathode voltage Vk and the reference voltage Vref and the comparison result counter 19 that outputs the digital value that changes in accordance with the average voltage at the feature points of the cathode voltage Vk by counting the value of the FF output signal UP in synchronization with the clock signal CLK. Therefore, according to the present embodiment, it is possible to accurately measure the average voltage by maintaining the measurement result for calculating the average voltage as a digital value for a long period of time. Note that although the above feature points are avalanche quenches in the present embodiment, the feature points may be other points (for example, a peak and a bottom of the cathode voltage Vk).

### Second Embodiment

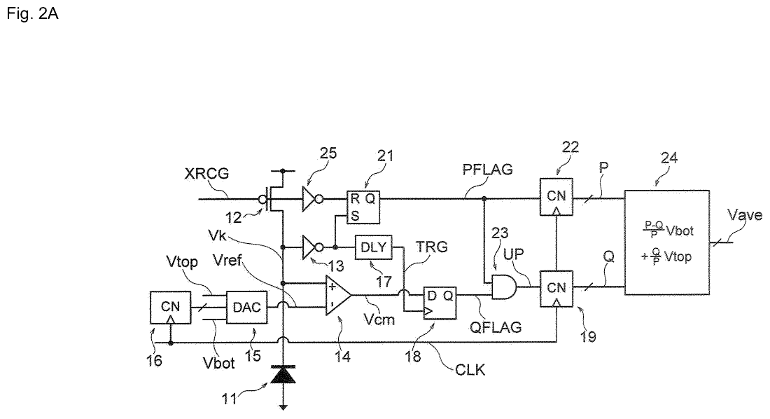

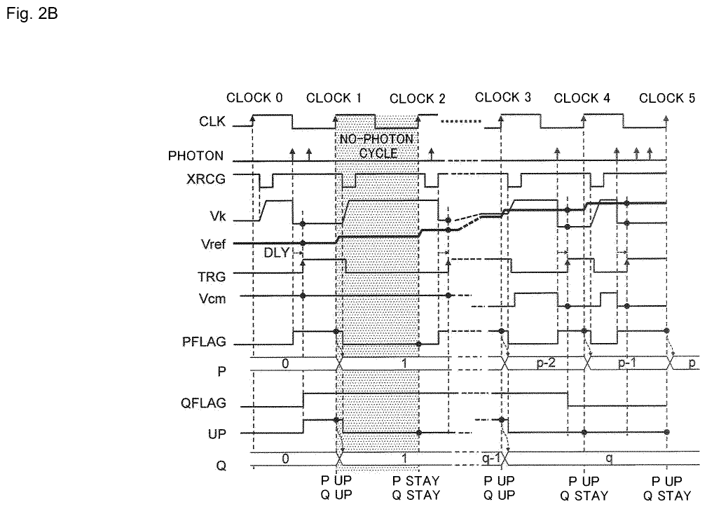

FIG. 2A is a circuit diagram illustrating a configuration of a light detection device according to a second embodiment.

The light detection device according to the present embodiment includes an RS-FF 21, a pulse counter 22, an AND gate 23, an arithmetic operation circuit 24, and an inverter 25 in addition to the components of the light detection device in the first embodiment. The pulse counter 22 is an example of the third counter according to the present disclosure.

The RS-FF 21 has a reset (R) terminal to which a recharge pulse (control signal) XRCG is input via the inverter 25, a set (S) terminal to which a cathode voltage Vk is input via the pulse detection circuit 13, and a Q terminal that outputs an FF output signal PFLAG to the pulse counter 22.

The pulse counter 22 counts the value of the FF output signal PFLAG in synchronization with the clock signal CLK and outputs a digital signal P indicating the counting result. If the value of the FF output signal PFLAG is 1 at a clock edge of the clock signal CLK, for example, the pulse counter 22 increments the count value of the digital signal P. On the other hand, if the value of the FF output signal PFLAG is 0 at the clock edge of the clock signal CLK, the count value of the digital signal P is held as it is. The value of the digital signal P indicates the result of counting the number of clock cycles at which feature points of the cathode voltage Vk have been detected.

The AND gate 23 has a first input terminal to which the FF output signal PFLAG from the Q terminal of the RS-FF 21 is input, a second input terminal to which the FF output signal QFLAG from the Q terminal of the D-FF 18 is input, and an output terminal that outputs a gate output signal UP indicating a logical AND of the FF output signal PFLAG and the FF output signal QFLAG. The FF output signal QFLAG in the present embodiment corresponds to the FF output signal UP in the first embodiment.

The comparison result counter 19 in the present embodiment outputs a digital value that changes in accordance with an average voltage at the feature points of the cathode voltage Vk by counting the value of the gate output signal UP in synchronization with the clock signal CLK. The comparison result counter 19 in the present embodiment outputs a digital signal Q indicating the digital value. The digital signal Q in the present embodiment corresponds to the digital signal D in the first embodiment.

The arithmetic operation circuit 24 calculates and outputs the average voltage Vave at the feature points of the cathode voltage Vk by using the digital signal P and the digital signal Q. The average voltage Vave in the present embodiment represents the average quench voltage. The average voltage Vave is calculated by Expression (4) below by using the digital signal P and the digital signal Q.

$$Vave = ( ( P - Q ) / Q ) Vbot + ( Q / p ) Vtop \qquad ( 4 )$$

In Expression (4), P denotes a value of the digital signal P, and Q denotes a value of the digital signal Q.

The pulse counter 22 counts the number of cycles when avalanche breakdown has occurred during a period from a certain clock to a next clock. The number of cycles is counted by using the FF output signal PFLAG from the RS-FF 21, and the digital signal P indicating the number of cycles is input from the pulse counter 22 to the arithmetic operation circuit 24.

The FF output signal PFLAG is also input to the AND gate 23 along with the FF output signal QFLAG. The AND gate 23 is provided to prevent the comparison result counter 19 from performing incrementing at a cycle when no breakdown occurs. Specifically the AND gate 23 prevents such incrementing by inputting the gate output signal UP instead of the FF output signal QFLAG to the comparison result counter 19. In other words, the AND gate 23 corrects the FF output signal QFLAG to the gate output signal UP. The arithmetic operation circuit 24 can thus calculate the average voltage Vave in consideration of an effect of the cycle when no breakdown has occurred.

FIG. 2B is a timing chart illustrating operations of the light detection device according to the second embodiment.

The value “1” of the comparison result signal Vcm is taken by the D-FF 18 at the cycle from the clock 0 to the clock 1 in FIG. 2B, and the comparison result counter 19 increments the count value at the clock 1. This is equivalent to the cycle from the clock 0 to the clock 1 in FIG. 1B.

The value “0” of the comparison result signal Vcm is taken by the D-FF 18 at the cycle from the clock 3 to the clock 4 in FIG. 2B, and the comparison result counter 19 holds the count value as it is at the clock 4. This is equivalent to the cycle from the clock 1 to the clock 2 in FIG. 1B.

Here, characteristics of photons will be considered. The photons are incident on the monitoring SPAD 11 at random intervals called Poisson arrival, and whether or not avalanche breakdown occurs at the photons that have been incident is also a probabilistic event. Therefore, cycles at which avalanche breakdown does not occur even once like the clock 1 to the clock 2 in FIG. 2B occurs in a probabilistically sporadic manner.

The components added in the present embodiment are provided to process cycles when the comparison results are invalid in a distinguished manner from the cycles when the comparison results are valid. In other words, the RS-FF 21 stores occurrence of avalanche breakdown and causes the pulse counter 22 to perform incrementing if new avalanche breakdown occurs. The cycle from the clock 0 to 1, the cycle from the clock 3 to 4, and the cycle from the clock 4 to 5 in FIG. 2B are examples thereof. If new avalanche breakdown does not occur like the clock 1 to the clock 2 in FIG. 2B, the pulse counter 22 holds the count value as it is, the value of the gate output signal UP is set to 0 regardless of the value of the FF output signal QFLAG, and the count value of the comparison result counter 19 is also held as it is.

In the first embodiment, it is assumed that avalanche breakdown occurs at all cycles, and the value p in Expression (3) is a constant value. However, if the cycles when no avalanche breakdown occurs increase, an error between the average voltage Vave represented by Expression (3) and the actual average voltage Vave increases.

Thus, a pulse count value defined by measurement is used as the value P in Expression (4) in the present embodiment. It is thus possible to reduce the above error. According to the present embodiment, it is possible to calculate the average value of the quench voltages from the values of Vbot, Vtop, P, and Q.

Reducing an influence of the cycles at which no avalanche breakdown occurs can also be achieved by sufficiently increasing the clock cycle time and reducing the occurrence probability of the invalid cycles to an ignorable level in the first embodiment. However, this means that the AD conversion time of the average voltage extremely increases in a case of low illuminance and a long photon arrival average intervals. According to the present embodiment, it is possible to measure the average quench voltage with high accuracy in a short period of time even with low illuminance through counting by the pulse counter 22 and correction by the AND gate 23.

### Third Embodiment

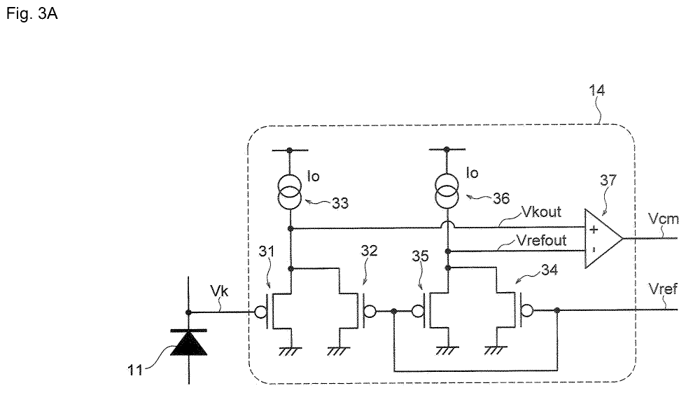

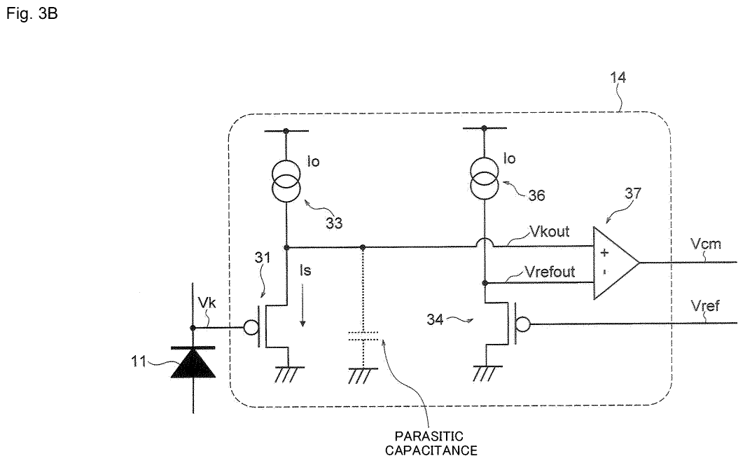

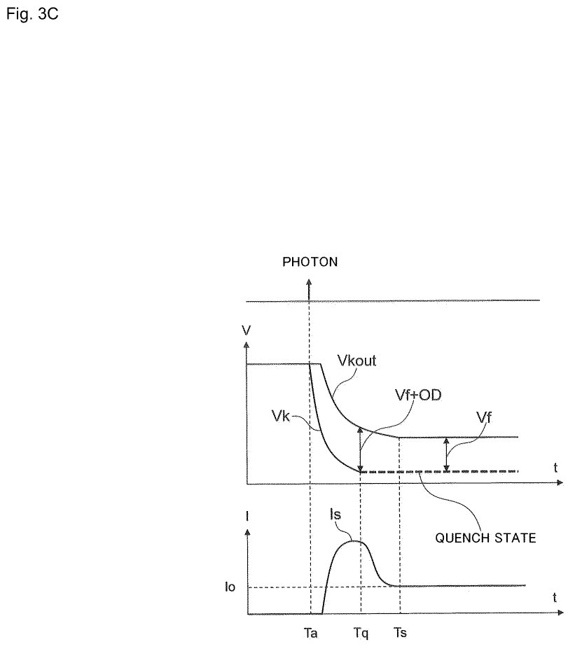

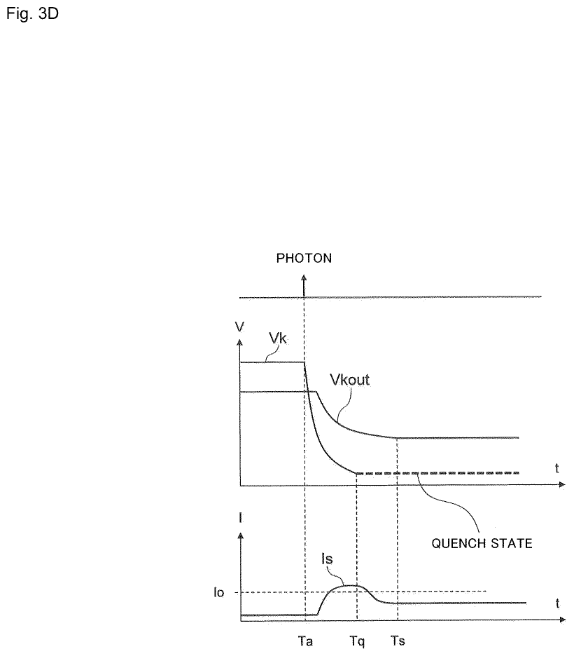

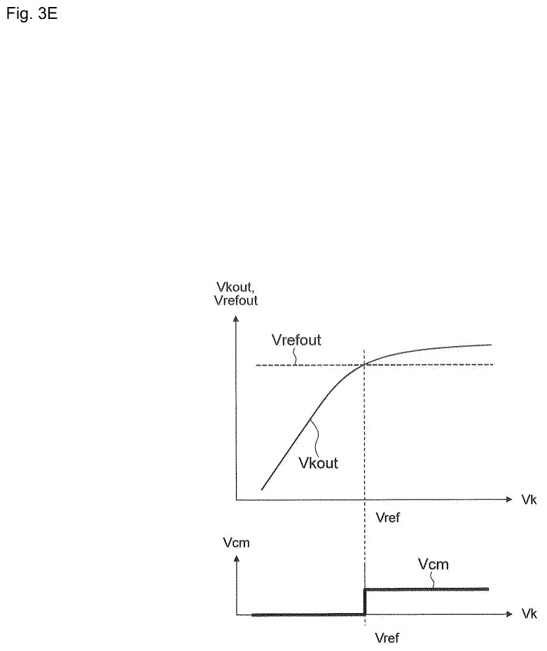

FIG. 3A is a circuit diagram illustrating a configuration of a comparison circuit 14 according to a third embodiment.

A light detection device according to the present embodiment includes the same components as those in the light detection device according to the first embodiment, and the comparison circuit 14 of the light detection device according to the present embodiment has a configuration illustrated in FIG. 3A. See FIG. 1A for the configuration of the light detection device according to the present embodiment in the following description. Note that the light detection device according to the present embodiment may include the same components as those in the light detection device according to the second embodiment.

The comparison circuit 14 according to the present embodiment includes a source follower transistor 31, a clamp transistor 32, a constant current source 33, a clamp transistor 34, a source follower transistor 35, a constant current source 36, and a comparator 37 that is a differential comparator. The source follower transistor 31 is an example of the first source follower according to the present disclosure. The source follower transistor 35 is an example of the second source follower according to the present disclosure.

The source follower transistor 31 has a gate to which a cathode voltage Vk is input, and the clamp transistor 32, the clamp transistor 34, and the source follower transistor 35 have gates to which a reference voltage Vref is input. A source or a drain of the source follower transistor 31 and a source or a drain of the clamp transistor 32 are electrically connected to the constant current source 33 and are electrically connected to a positive input terminal of the comparator 37. A source or a drain of the clamp transistor 34 and a source or a drain of the source follower transistor 35 are electrically connected to the constant current source 36 and are electrically connected to a negative input terminal of the comparator 37. The comparator 37 has a positive input terminal to which a voltage Vkout is input, a negative input terminal to which a voltage Vrefout is input, and an output terminal to which a comparison result signal Vcm is output.

A cathode of the monitoring SPAD 11 has a high impedance as a signal source. Thus, the comparison circuit 14 according to the present embodiment includes the source follower transistor 31 using the cathode voltage Vk as an input in a stage before the positive input terminal of the comparator 37. The source follower transistor 31 is, for example, a PMOS. The comparison circuit 14 according to the present embodiment further includes a source follower transistor 35 using the reference voltage Vref as an input in a stage before the negative input terminal of the comparator 37 as well in order to compensate for a voltage shift due to the source follower transistor 31 and accurately compare the cathode voltage Vk with the reference voltage Vref. The source follower transistor 35 is, for example, a PMOS. Also, the source follower transistor 35 according to the present embodiment is congruent to the source follower transistor 31.

The comparison circuit 14 according to the present embodiment further includes the clamp transistor 32 electrically connected to the source follower transistor 31 and the clamp transistor 34 electrically connected to the source follower transistor 35. In the present embodiment, the source follower transistor 31 and the clamp transistor 32 are connected with a common source, and the source follower transistor 35 and the clamp transistor 34 are also connected with a common source. The clamp follower transistors 32 and 34 are, for example, PMOSs.

In the present embodiment, a source follower output (voltage Vkout) of the source follower transistor 31 is input to the positive input terminal of the comparator 37, and a source follower output (voltage Vrefout) of the source follower transistor 35 is input to the negative input terminal of the comparator 37.

FIG. 3B is a circuit diagram illustrating a configuration of a comparison circuit 14 according to a comparative example of the third embodiment.

The comparison circuit 14 according to this comparative example has a configuration excluding the clamp transistor 32 and the source follower transistor 35 from the comparison circuit 14 according to the third embodiment. FIG. 3B further illustrates a parasitic capacitance for a positive input terminal of the comparison circuit 14 according to this comparative example.

FIG. 3C is a timing chart illustrating operations of the comparison circuit 14 according to the comparative example of the third embodiment.

A cathode voltage Vk sticks to the positive power source voltage until avalanche breakdown occurs after the monitoring SPAD 11 is recharged, and the source follower output Vkout is also saturated at the positive power source voltage. Once avalanche breakdown occurs and the cathode voltage Vk suddenly drops, the source follower output Vkout also follows it and drops. At this time, in order to discharge the parasitic capacitance in FIG. 3B, a gate-source voltage of the source follower transistor 31 has a potential difference that is greater than the static voltage Vf by an overdrive voltage OD, and a source current Is of the source follower transistor 31 is a value that is equal to or greater than a bias current Io.

If the source follower output Vkout ends the following, the gate-source voltage stands still at the static voltage Vf, and the source current Is returns to the bias current Io. The decrease in the source current Is to the bias current Io continues even after the monitoring SPAD 11 quenches and is brought into a Hi-Z state. The decrease in the source current Is is also a decrease in channel charge of the source follower transistor 31, and the decrease in channel charge causes a current to flow to the cathode of the monitoring SPAD 11 facing the channel via the gate capacity of the source follower transistor 31.

Hereinafter, the gate current will be referred to as kickback from the source follower transistor 31. In order to reduce the kickback, slowly discharging the parasitic capacitance with the source follower transistor 31 reduced in size is also effective. However, this leads to an increase in delay time of the comparator 37. Since it is necessary to confirm the comparison result signal Vcm before the trigger signal TRG generated by the delay circuit 17 is turned on, an increase in delay time is not desirable.

FIG. 3D is a timing chart illustrating operations of the comparison circuit 14 according to the third embodiment.

An output unit of the source follower transistor 31 with the clamp transistor 32 added thereto functions as a minimum value circuit of a gate input of the source follower transistor 31 and a gate input of the clamp transistor 32. When the gate input voltage (=Vk) of the source follower transistor 31 is sufficiently higher than the gate input voltage (=Vref) of the clamp transistor 32, the source follower output Vkout is fixed to a voltage determined by the gate input voltage of the clamp transistor 32. Therefore, the source follower output Vkout waits at a lower voltage than the positive power source even before avalanche breakdown as illustrated in FIG. 3D. As a result, the parasitic capacitance charge to be discharged before the source follower output Vkout follows avalanche breakdown and the cathode voltage Vk that has decreased due to the quench. Therefore, a change in source current Is is small, and kickback can be reduced to a low level.

FIG. 3E is a graph for explaining operations of the comparison circuit 14 according to the third embodiment.

Although an input-output relationship of the source follower transistor 31 including the clamp transistor 32 is not linear, the relationship is not strong bending like an ideal minimum value circuit and has a monotonic increase property of slow saturation as in FIG. 3E. The comparison circuit 14 according to the present embodiment inputs, to the negative input terminal of the comparator 37, the source follower output Vrefout obtained by giving the reference voltage Vref to the gates of both the source follower transistor 35 and the clamp transistor 34. In this manner, the comparator 37 can output the comparison result signal Vcm that accurately reflects the magnitude relationship between the cathode voltage Vk and the reference voltage Vref.

Influences of the kickback becomes significant when the size of the monitoring SPAD 11 is reduced, the speed thereof is increased, and the cathode capacity is reduced. In a case where the cathode capacity is in a generation of 1 to 2 fF, and a 3V voltage-resistant PMOS transistor is used as the source follower transistor 31, a shift of the cathode voltage Vk due to kickback is several tens of mV in the comparison circuit 14 in FIG. 3B. On the other hand, the shift is as small as several mV, and more accurate determination of the quench voltage is possible in the comparison circuit 14 in FIG. 3A.

### Fourth Embodiment

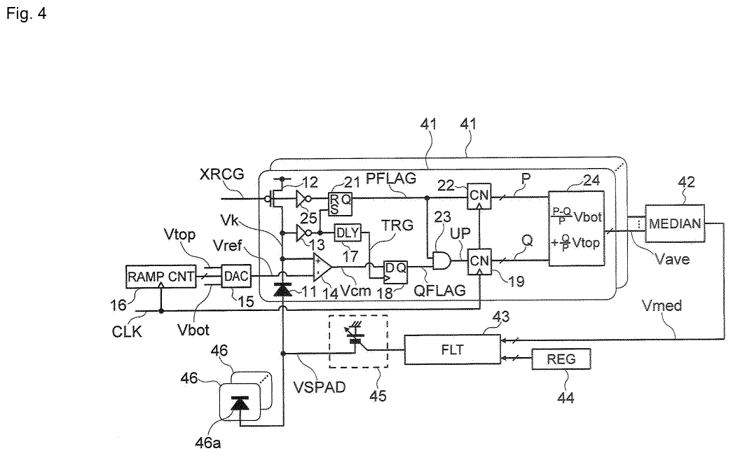

FIG. 4 is a circuit diagram illustrating a configuration of a light detection device according to a fourth embodiment.

The light detection device according to the present embodiment includes a plurality of light detection units 41. Each light detection unit 41 includes a monitoring SPAD 11, a recharge transistor 12, a pulse detection circuit 13, a comparison circuit 14, a delay circuit 17, a D-FF 18, a comparison result counter 19, an RS-FF 21, a pulse counter 22, an AND gate 23, an arithmetic operation circuit 24, and an inverter 25 similarly to the light detection device according to the second embodiment.

The light detection device according to the present embodiment further includes a DAC 15, a lamp counter 16, a median search circuit 42, a digital filter 43, a target voltage value register 44, a power IC 45, and a plurality of imaging pixels 46 as components that are common to these light detection units 41. Each imaging pixel 46 includes an imaging SPAD 46a. The imaging SPAD 46a is an example of the second diode according to the present disclosure.

The DAC 15 and the lamp counter 16 according to the present embodiment have configurations similar to those in the second embodiment. A reference voltage Vref from the DAC 15 is input to a negative input terminal of the comparison circuit 14 of each light detection unit 41.

The median search circuit 42 receives a plurality of average quench voltages Vave from the plurality of light detection units 41 and searches for and output a median Vmed of these average quench voltages Vave. The light detection device according to the present embodiment may include an average value calculation circuit that calculates and outputs an average value of these average quench voltages Vave instead of the median search circuit 42. However, in a case where the number of light detection units 41 is not too large, there is a trend that the median is a value that more accurately reflects the characteristic of the average quench voltages Vave than the average value.

The digital filter 43 receives the median Vmed from the median search circuit 42 and reads a quench voltage target value stored in the target voltage value register 44. The digital filter 43 further compares the median Vmed with the quench voltage target value and performs a proportional-integral-differential (PID) arithmetic operation in accordance with a difference between the median Vmed and the quench voltage target value. The digital filter 43 further generates and outputs an NFB control signal to cause the median Vmed to approach the quench voltage target value on the basis of a result of the proportional-integral-differential (PID) arithmetic operation.

The power IC 45 generates a VSPAD voltage in accordance with an NFB control signal from the digital filter circuit 43 and supplies a SPAD voltage to the anode of the monitoring SPAD 11 of each light detection unit 41. As a result of the NFB control, the median Vmed of the average quench voltages Vave approaches asymptotically the quench voltage target value and is then held.

The VSPAD voltage is also supplied to the anode of the imaging SPAD 46a of each imaging pixel 46. Therefore, the median of the average quench voltages of the imaging SPADs 46a of the above plurality of imaging pixels 46 also approaches asymptotically to the above quench voltage target value and is then held.

Each light detection unit 41 according to the present embodiment outputs digital signals P and Q and outputs the average quench voltage Vave in accordance with the digital signals P and Q. The median search circuit 42, the digital filter 43, the target voltage value register 44, and the power IC 45 according to the present embodiment forms a feedback circuit that generates the NFB control signal in accordance with the average quench voltages Vave and feeds back the NFB control signal to the monitoring SPAD 11 of each light detection unit 41. It is thus possible to cause the median Vmed of the average quench voltages Vave to approach the quench voltage target value.

According to the present embodiment, it is possible to compensate for variations in SPAD breakdown voltage due to temperature properties and variations among manufacturing lots and continuously keep the average Vave of the quench voltage constant. Since the quench occurs due to the monitoring SPAD 11 losing an excessive voltage, the voltage difference between the quench voltage and the positive power source voltage is the excessive voltage and keeping the quench voltage constant is also keeping the excessive voltage. The probability that the photon incident on the monitoring SPAD 11 causes avalanche breakdown, that is, photon detection efficiency (PDE) is strongly dominated by the excessive voltage. Therefore, controlling the quench voltage and stabilizing the excessive voltage leads to stabilizing imaging sensitivity due to SPAD photon counting and leads to stabilization of image quality.

### Fifth Embodiment

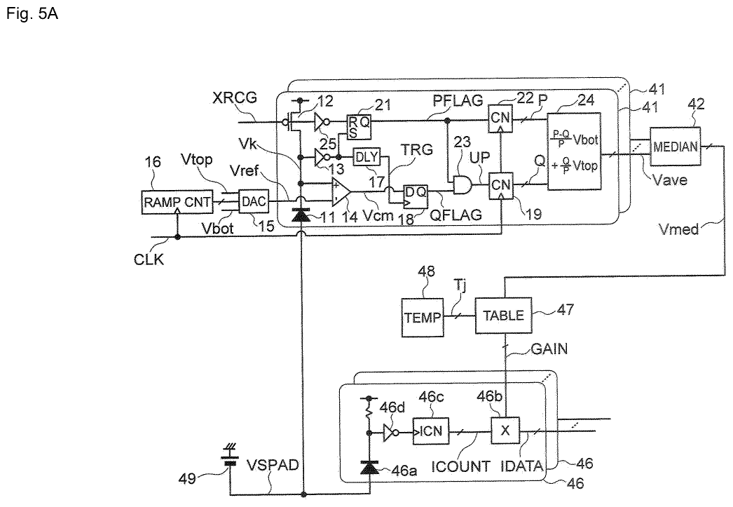

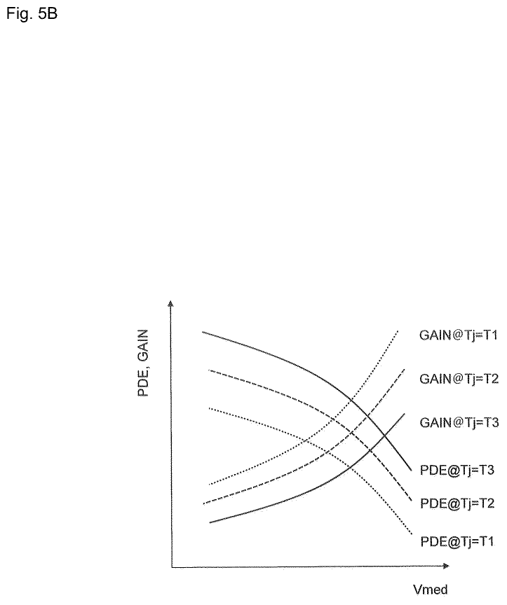

FIG. 5A is a circuit diagram illustrating a configuration of a light detection device according to a fifth embodiment.

The light detection device according to the present embodiment includes components similar to those in the light detection device according to the fourth embodiment and includes a PDE correction table 47, a thermometer 48, and a fixed power source 49 instead of the digital filter 43, the target voltage value register 44, and the power IC 45. FIG. 5A illustrates an imaging SPAD 46a, a correction coefficient multiplier 46b, an imaging counter 46c, and an inverter 46d in each imaging pixel 46.

The light detection device according to the present embodiment applies a fixed voltage VSPAD from the fixed power source 49 to an anode of the monitoring SPAD 11 of each light detection unit 41. The fixed voltage VSPAD from the fixed power source 49 is also applied to an anode of the imaging SPAD 46a of each imaging pixel 46. The light detection device according to the present embodiment measures a quench voltage of the monitoring SPAD 11 of each light detection unit 41 and corrects photon count data obtained from the imaging SPAD 46a of each imaging pixel 46.

A median search circuit 42 according to the present embodiment receives a plurality of average quench voltages Vave from the plurality of light detection units 41 and outputs a median Vmed of these average quench voltages Vave to the PDE correction table 47. The PDE correction table 47 determines a correction coefficient GAIN on the basis of the median Vmed from the median search circuit 42 and a junction temperature Tj from the thermometer 48.

FIG. 5B is a graph for explaining operations of the light detection device according to the fifth embodiment.

The correction coefficient GAIN is a reciprocal of the PDE determined as a function of the median Vmed and the junction temperature Tj as illustrated in FIG. 5B. In each imaging pixel 46, the imaging counter 46c outputs a photon count ICOUNT in accordance with the cathode voltage received from the imaging SPAD 46a via the inverter 46d, and the correction coefficient multiplier 46b generates correction imaging data IDATA in accordance with the photon count ICOUNT. At this time, the correction coefficient multiplier 46b generates correction imaging data IDATA by multiplying the photon count ICOUNT by the correction coefficient GAIN. The correction coefficient multiplier 46b may perform numerical value multiplication or may cause a period during which the photon count is executed, that is, an exposure time to be proportional to the correction coefficient GAIN.

Each light detection unit 41 according to the present embodiment outputs digital signals P and Q and outputs an average quench voltage Vave in accordance with the digital signals P and Q. The median search circuit 42, the plurality of imaging pixels 46, the PDE correction table 47, the thermometer 48, and the fixed power source 49 according to the present embodiment form a correction circuit that performs PDE correction in accordance with the average quench voltage Vave. It is thus possible to correct variations in PDE occurring due to changes in quench voltage and excessive voltage caused by the individual difference of the fixed voltage VSAPD and variations in drift and to stabilize imaging sensitivity.

### Sixth Embodiment

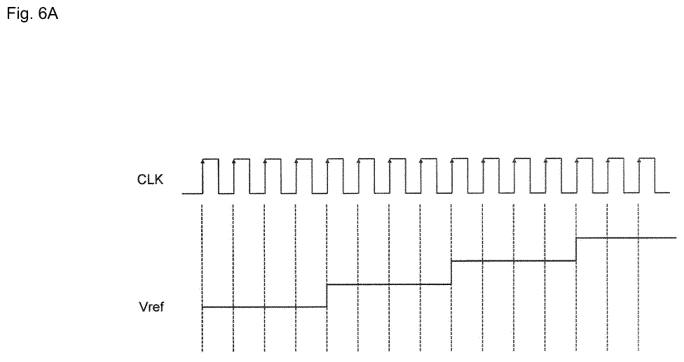

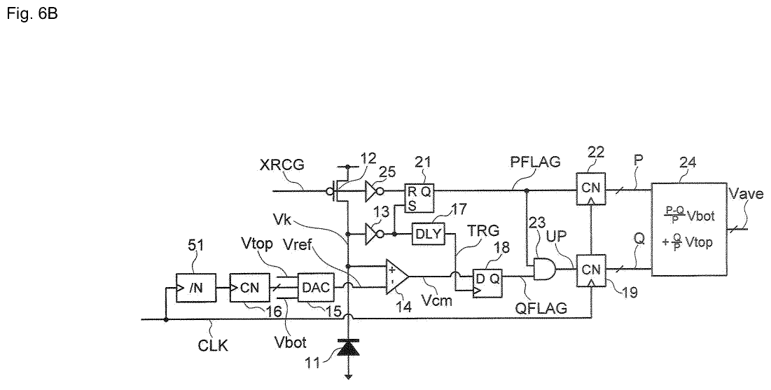

FIG. 6A is a timing chart illustrating operations of a light detection device according to a sixth embodiment.

The light detection device according to the present embodiment sweeps a reference voltage Vref by increasing the reference voltage Vref in a stepwise manner at a proportion of once a plurality of clock cycles as illustrated in FIG. 6A. Although the reference voltage Vref in the present embodiment increases at a proportion of once four clock cycles, the reference voltage Vref may increase at a proportion of once K clock cycles (K is an integer that is other than 4).

FIG. 6B is a circuit diagram illustrating a configuration of the light detection device according to the sixth embodiment.

The light detection device according to the present embodiment includes a frequency divider 51 in addition to the components of the light detection device according to the second embodiment. The frequency divider 51 divides a frequency of the clock signal CLK and outputs the clock signal CLK subjected to the frequency division to the lamp counter 16. As a result, the DAC 15 controlled by the lamp counter 16 outputs a reference voltage Vref as illustrated in FIG. 6A.

For example, a case where the DAC 15 sweeps the reference voltage Vref from Vbot to Vtop and the comparison circuit 14 compares the cathode voltage Vk (quench voltage) with the reference voltage Vref 1024 times will be assumed. In this case, the DAC 15 according to the second embodiment increases the reference voltage Vref by 1/1024 of the voltage difference between Vtop and Vbot every one cycle of the clock signal CLK. On the other hand, the DAC 15 according to the present embodiment increases the reference voltage Vref by 1/256 of the voltage difference between Vtop and Vbot every four cycles of the clock signal CLK. As a result, the increasing voltage of the reference voltage Vref in the present embodiment increases to four times the increasing voltage of the reference voltage Vref in the second embodiment. However, if the increasing voltage in the present embodiment is sufficiently smaller than the width of the fluctuation of the quench voltage, probability distribution of the input voltage difference of the comparison circuit 14 is approximated as illustrated in FIG. 1D, and it is thus possible to accurately measure the average value of the quench voltages.

According to the present embodiment, it is possible to execute comparison between the cathode voltage Vk and the reference voltage Vref a large number of times even if the number of gradations of the DAC 15 is small, and it is possible to perform AD conversion with high precision with small statistical fluctuation with respect to the average quench voltage Vave.

### Seventh Embodiment

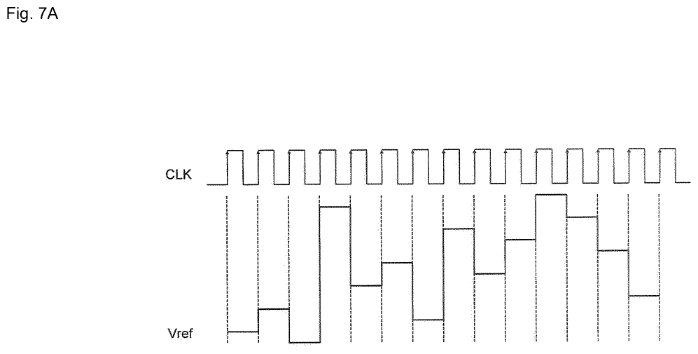

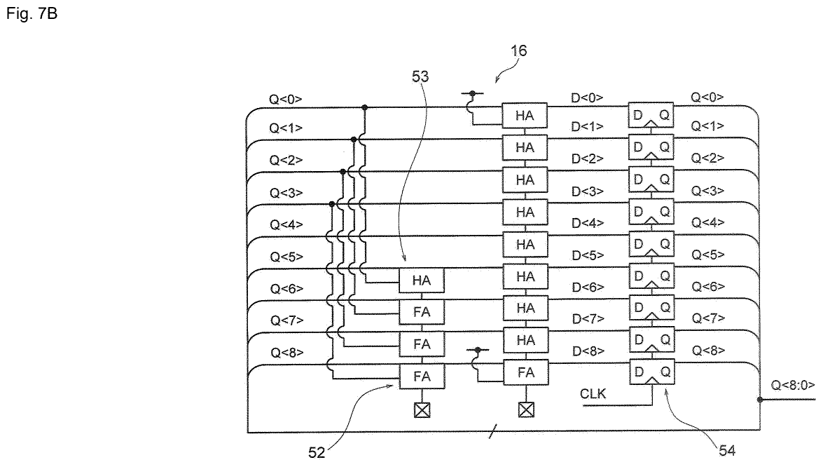

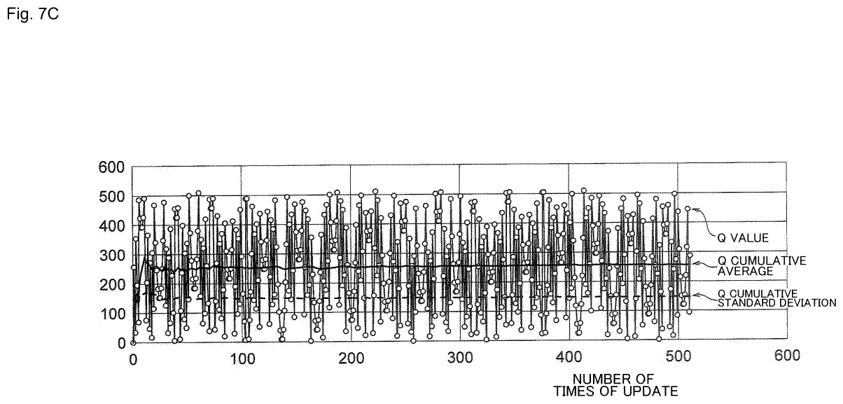

FIG. 7A is a timing chart illustrating operations of a light detection device according to a seventh embodiment.

The light detection device according to the present embodiment sweeps a reference voltage Vref by increasing and decreasing the reference voltage Vref in a stepwise manner as illustrated in FIG. 7A. The reference voltage Vref illustrated in FIG. 7A randomly increases or decreases in synchronization with a clock signal CLK. The light detection device according to the present embodiment updates the value of the reference voltage Vref with a pseudo random value that changes in synchronization with the clock signal CLK. It is thus possible to generate the reference voltage Vref that randomly increases or decreases. The reference voltage Vref in the present embodiment is updated every one clock cycle, the reference voltage Vref may be updated every multiple clock cycles as in the sixth embodiment.

FIG. 7B is a circuit diagram illustrating a configuration of a lamp counter 16 according to the seventh embodiment.

Although the light detection device according to the present embodiment includes components similar to those in the light detection device according to the first embodiment, the lamp counter 16 according to the present embodiment has a configuration illustrated in FIG. 7B, for example. The lamp counter 16 according to the present embodiment includes a plurality of (here, four) full adders 52, a plurality of (here, nine) half adders 53, and a plurality of (here, nine) D-FFs 54. A 9-bit output Q<8:0> of the lamp counter 16 according to the present embodiment is updated through an arithmetic operation based on the linear congruential method represented by Expression (5).

$$Qn + 1 ← ( 33 * Qn + 257 ) \%512 \qquad ( 5 )$$

FIG. 7C is a graph for explaining operations of the light detection device according to the seventh embodiment.

FIG. 7C illustrates a Q value at every update, an average value of a number sequence of Q until the update, and a standard deviation of the number sequence of Q until the update with the number of times of the update after reset taken as a horizontal axis. The update of Q using Expression (5) is performed 512 times in one turn and is repeated, and FIG. 7C illustrates that the average value and the standard deviation become substantially constant values once the number of times of update exceeds 100 times. Once such Q is input from the lamp counter 16 to the DAC 15, the reference voltage Vref substantially uniformly sweeps the part between Vbot and Vtop in an early stage of the sweeping period.

This is a characteristic of the random sweep in the present embodiment which is significantly different from sweep performed in an ascending order or a descending order. In the sweep performed in an ascending order or a descending order, an accurate AD conversion result is typically not obtained until the sweep of the part between Vbot and Vtop is ended. On the other hand, according to the random sweep in the present embodiment, a substantially accurate AD conversion result is obtained in an early stage of the sweep, and an AD conversion result with less statistical fluctuation is obtained with advancement of the sweep.

According to the present embodiment, it is possible to perform light detection that is robust to abnormal situations such as a situation in which the AD conversion of the average quench voltage Vave is suddenly discontinued for some reasons.

### Eighth Embodiment

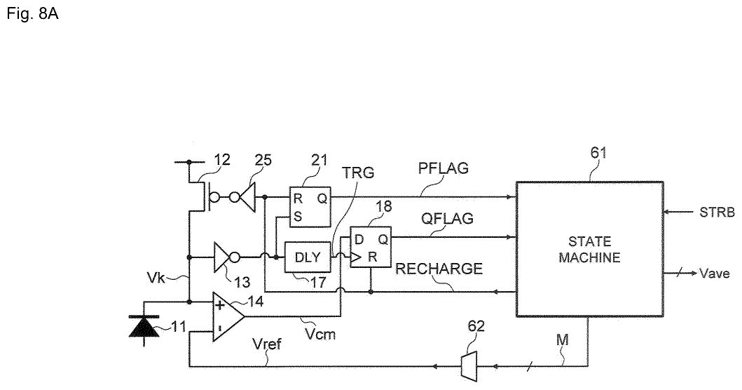

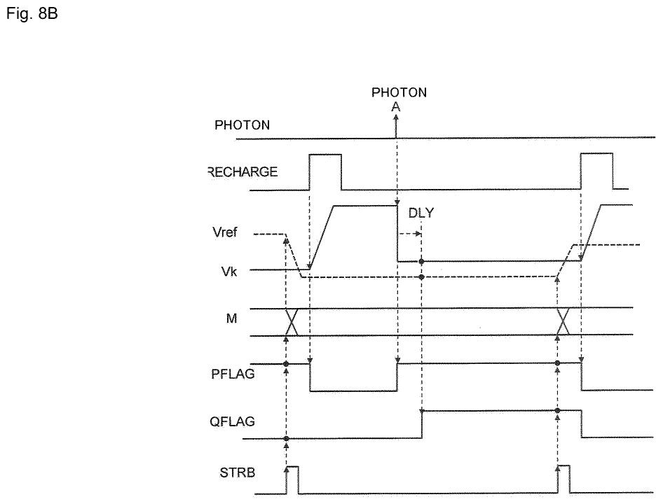

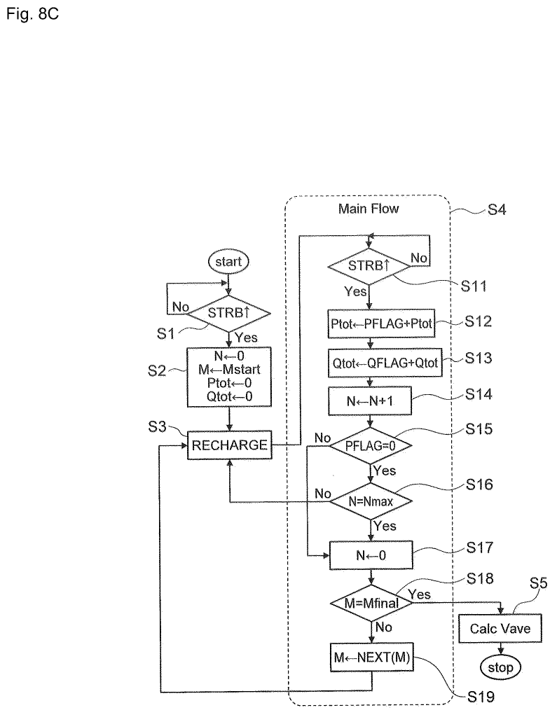

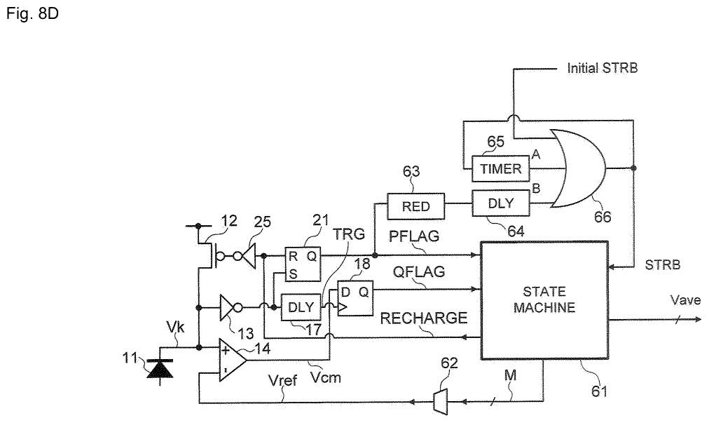

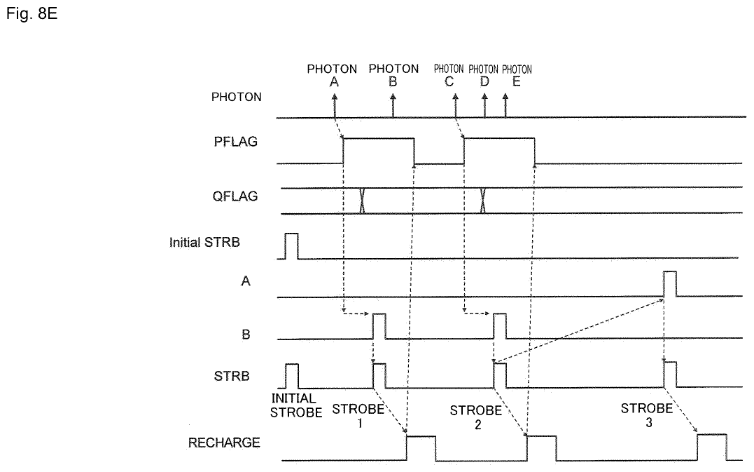

FIG. 8A is a circuit diagram illustrating a configuration of a light detection device according to an eighth embodiment.

Although the light detection device according to the present embodiment includes components similar to those in the light detection device according to the second embodiment, the light detection device according to the present embodiment includes a state machine 61 and a DAC 62 instead of the DAC 15, the lamp counter 16, the comparison result counter 19, the pulse counter 22, the AND gate 23, and the arithmetic operation circuit 24.

The state machine 61 outputs a RECHARGE signal. The RECHARGE signal is input to a gate of a recharge transistor 12 via an inverter 25. In this manner, the light detection device according to the present embodiment supplies the RECHARGE signal instead of the control signal XRCG to the recharge transistor 12. The recharge transistor 12 according to the present embodiment is a PMOS.

In the present embodiment, a pulse caused by a cathode voltage Vk is input from a pulse detection circuit 13 to an S terminal of an RS-FF 21 in a case where the value of the cathode voltage Vk is less than a threshold value. On the other hand, the RECHARGE signal from the state machine 61 is input to an R terminal of the RS-FF 21. The RS-FF 21 outputs an FF output signal PFLAG from a Q terminal in response to input signals to the S terminal and the R terminal.

The DAC 62 outputs a Vref signal in response to a DAC input signal M output from the state machine 61. The Vref signal is input to a negative input terminal of the comparison circuit 14 via the DAC 62. The comparison circuit 14 compares the cathode voltage Vk with the reference voltage Vref and outputs a comparison result signal Vcm indicating the comparison result, The D-FF 18 has a D terminal to which the comparison result signal Vcm is input, a CLK terminal to which a trigger signal TRG is input, an R terminal to which the RECHARGE signal is input, and a Q terminal that outputs an FF output signal QFLAG.

The state machine 61 receives a strobe (STRB) signal, the FF output signal PFLAG, and the FF output signal QFLAG and outputs the RECHARGE signal, the DAC input signal (DAC bus signal) M, and the average quench voltage (quench bus signal) Vave. Specifically the state machine 61 outputs the average quench voltage Vave in response to the FF output signal PFLAG and the FF output signal QFLAG. It is thus possible to accurately measure the average quench voltage Vave by the state machine 61 in a short period of time.

FIG. 8B is a timing chart illustrating operations of the light detection device according to the eighth embodiment.

FIG. 8B illustrates operations of the light detection device during one cycle (STRB cycle) of the STRB signal. The state machine 61 takes the values of PFLAG and QFLAG at rising of the STRB signal and updates the value of the DAC input signal M. The DAC 62 updates the value of the reference voltage Vref in response to the update of the value of M.

Also, the state machine 61 outputs, as the RECHARGE signal, a pulse with a width with which the cathode voltage Vk is completely charged to a positive power source potential. At the same time, the pulse of the RECHARGE signal is input to the R terminal of the RS-FF 21 of the D-FF 18 and resets the values of PFLAG and QFLAG.

The charged cathode voltage Vk suddenly drops if a photon is incident on the monitoring SPAD 11 and avalanche breakdown occurs, and still stands at the quench voltage. Once the drop is detected by the pulse detection circuit 13, PFLAG is set again. Also, the delay circuit 17 responds with a delay and the trigger signal TRG is taken by the D-FF 18. As a result, an operation of the D-FF 18 is triggered by the trigger signal TRG.

In FIG. 8B, the value of the comparison result signal Vem at the time of the trigger is 1 since Vk>Vref. The comparison result signal Vem at the timing of the trigger is taken by the D-FF 18, and an influence thereof appears in QFLAG. The values of PFLAG and QFLAG determined with the avalanche breakdown are taken by the state machine 61 at next rising of the STRB signal, and a similar cycle is repeated.

FIG. 8C is a flowchart illustrating operations of the light detection device according to the eighth embodiment. FIG. 8C illustrates operations of the state machine 61.

According to the flow in FIG. 8C, the state machine 61 updates the reference voltage Vref with the DAC input signal M once avalanche breakdown occurs in the STRB cycle (see Step S19). On the other hand, the state machine 61 repeats the strobe cycle with the same voltage Vref until an allowable maximum number of times Nmax unless no avalanche breakdown has occurred in the STRB cycle (see Step S16). Once the STRB cycle ends for all the values of the reference voltage Vref that can be updated, the state machine 61 calculates the average quench voltage Vave on the basis of the count of the result obtained at the STRB cycle at each value of the reference voltage Vref (see Step S5).

The started state machine 61 waits for the first rising of the STRB signal (Step S1). Once the first rising of the STRB signal is detected, the state machine 61 performs, as initialization tasks, 0 clear of the N counter, initial value setting of the M counter, 0 clear of the Ptot counter, and 0 clear of the Qtot counter first (Step S2). Next, the state machine 61 sends a pulse of the RECHARGE signal (Step S3). Thereafter, the flow of FIG. 8C proceeds to a main flow.

In the main flow, the state machine 61 waits for rising of the STRB signal (Step S11). Once the rising of the STRB signal is detected, the state machine 61 reads PFLAG and QFLAG from the RS-FF 21 and the D-FF 18. The state machine 61 increments the value of the Ptot counter if the read value of PFLAG is 1, or holds the value of the Ptot counter if the read value of PFLAG is 0 (Step S12). Similarly, the state machine 61 increments the value of the Qtot counter if the read value of QFLAG is 1, or holds the value of the Qtot counter if the read value of QFLAG is 0 (Step S13). The state machine 61 further increments the value of the N counter with no conditions (Step S14).

In the main flow, a flow branch is selected at a conditional branch based on the values of PFLAG, the N count, and the M count (Steps S15 to S19).

If PFLAG is 1, the state machine 61 clears the N counter to 0 and determines whether or not the M counter indicates the final value Mfinal (Steps S15, S17, S18). In a case of a positive determination, it means that sweep of all the values of the DAC input signal M has ended, and the state machine 61 thus drops out from the main flow, calculates the average quench voltage Vave, and ends the operations (Step S5). On the other hand, in a case of negative determination, the state machine 61 updates the value of the M counter, drops out from the main flow, and returns to Step S3 (Step S19). The update of the value of the M counter may be forward calculation, backward calculation, or calculation based on a pseudo random number generation scheme.

If PFLAG is 0, the state machine 61 determines whether or not the value of the N counter has reached the maximum allowable value Nmax (Steps S15, S16). In a case of negative determination, the state machine 61 drops out from the main flow and returns to Step S3 (Step S16). This means that since avalanche breakdown has not occurred in the STRB cycle and the number of repetitions N is less than the maximum allowable value Nmax, the pulse detection and the quench voltage determination are repeated again with the reference voltage Vref of the same value without updating the value of the M counter. On the other hand, in a case of positive determination, the processing meets the branch chosen when PFLAG is 1, and the N counter is cleared to 0 (Steps S16, S17). This means that although no avalanche breakdown has occurred in the STRB cycle, the number of repetitions N has reached the maximum allowable value Nmax, the value of the M counter is thus updated, and the pulse detection and the quench voltage determination are performed with the reference voltage Vref of another value from here on.

In the present embodiment, the detection of avalanche breakdown and the determination of the quench voltage are repeated with the reference voltage Vref maintained at the same value in a case where illuminance is low and the frequency of avalanche breakdown is low. This means that unlike the second embodiment in which comparison using the reference voltage Vref is immediately canceled in a case where no avalanche breakdown occurs in the clock cycle, the comparison using the reference voltage Vref can be performed again. In other words, if the STRB cycle is shortened, the detection and comparison time is adjusted to adapt occurrence of avalanche breakdown in the present embodiment. According to the present embodiment, it is possible to completely finish the comparison between all the values of the reference voltage Vref and the quench voltage in a short period of time by appropriately setting the STRB cycle and the Nmax value and to obtain the average quench voltage Vave with less statistical fluctuation in a short period of time even with low illuminance.

FIG. 8D is a circuit diagram illustrating a configuration of a light detection device according to a modification example of the eighth embodiment.

The light detection device according to the modification example includes a rising detection circuit 63, a delay circuit 64, a timer 65, and an OR gate 66 in addition to the components of the light detection device according to the eighth embodiment. The light detection device according to the modification example inputs an STRB signal generated on the basis of PFLAG to the state machine 61 instead of inputting the STRB signal at a constant cycle to the state machine 61.

FIG. 8E is a timing chart illustrating operations of the light detection device according to the modification example of the eighth embodiment.

In the modification example, once avalanche breakdown occurs in the monitoring SPAD 11, the rising detection circuit 63 detects rising of PFLAG and generates a pulse. The delay circuit 64 delays the pulse by a grace period for the state machine 61 to take QFLAG. FIG. 8E illustrates the pulse output from the delay circuit 64 with the reference sign B. The pulse is supplied as an STRB pulse to the state machine 61 via the OR gate 66. In this manner, the state machine 61 does not update the reference voltage Vref until avalanche breakdown is detected.

However, the light detection device according to the modification example inputs an initial STRB signal and the signal from the timer 65 to the OR gate 66 in order to avoid hang-up at the time of starting of the state machine 61 or in a case where no avalanche breakdown occurs at all. The OR gate 66 supplies a logical sum of the signal from the delay circuit 64, the signal from the timer 65, and the initial STRB signal as a STRB signal to the state machine 61. FIG. 8E illustrates the signal (pulse) output from the timer 65 with the reference sign A.

### Ninth Embodiment

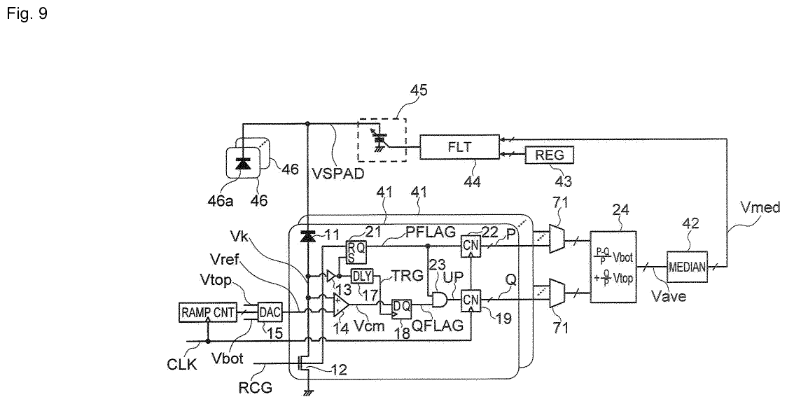

FIG. 9 is a circuit diagram illustrating a configuration of a light detection device according to a ninth embodiment.

The light detection device according to the present embodiment includes two multiplexing circuits (MUXs) 71 in addition to the components of the light detection device according to the fourth embodiment. Each of the monitoring SPADs 11 according to the first to eighth embodiments is biased with a common anode, and a quench voltage generated at a cathode due to avalanche breakdown is measured. On the other hand, each monitoring SPAD 11 according to the present embodiment is biased with a common cathode, and a quench voltage generated at the anode due to avalanche breakdown is measured.

Therefore, the anode of the monitoring SPAD 11 is electrically connected to the recharge transistor 12, the pulse detection circuit 13, and the comparison circuit 14 in each light detection unit 41. Also, the cathode of the monitoring SPAD 11 is electrically connected to cathodes of a power IC 45 and each imaging SPAD 46. An anode voltage of each monitoring SPAD 11 in the present embodiment is an example of the signal voltage according to the present disclosure.

The light detection device according to the present embodiment includes a plurality of light detection units 41 similarly to the light detection device according to the fourth embodiment, and these light detection units 41 share an arithmetic operation circuit 24. Once sweep of the reference voltage Vref ends, and values of P and Q of these light detection units 41 are confirmed, the values of P and Q of these light detection units 41 are successively read by the MUXs 71 on the arithmetic operation circuit 24 and are converted into average quench values Vave of each light detection unit 41. In the above two MUXs 71, one of the MUXs 71 successively reads the value of P while the other MUX 71 successively reads the value of Q. The median search circuit 42 receives a plurality of average quench voltages Vave from the plurality of light detection units 41 and searches for and output a median Vmed of these average quench voltages Vave.

### Tenth Embodiment

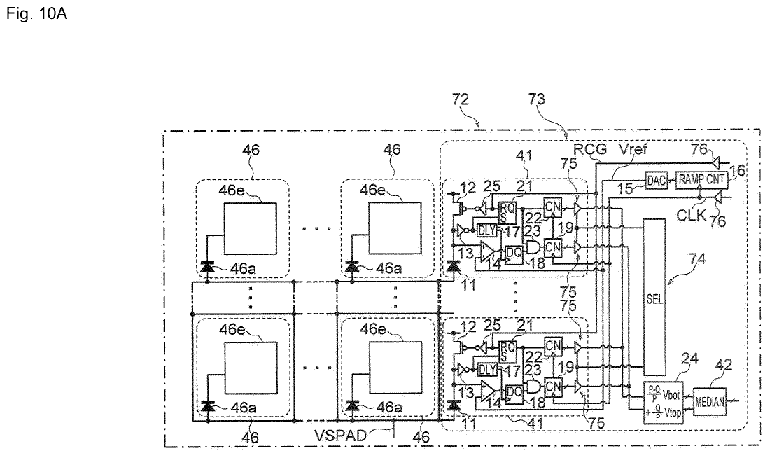

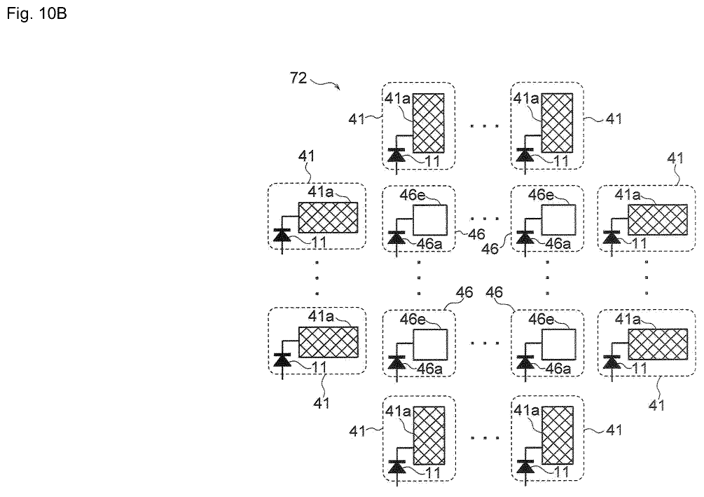

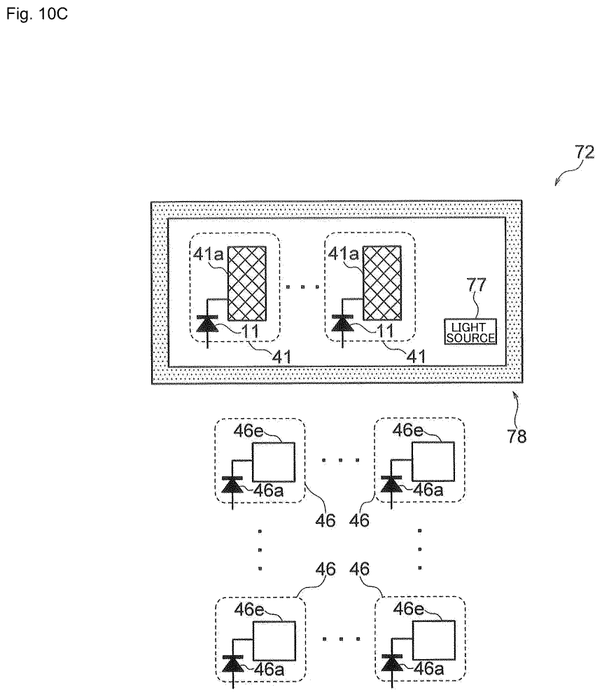

FIG. 10A is a circuit diagram illustrating a configuration of a light detection device according to a tenth embodiment.

The light detection device according to the present embodiment includes a semiconductor substrate 72 and a quench voltage measurement circuit 73. The quench voltage measurement circuit 73 includes a plurality of light detection units 41. Each light detection unit 41 includes a monitoring SPAD 11, a recharge transistor 12, a pulse detection circuit 13, a comparison circuit 14, a delay circuit 17, a D-FF 18, a comparison result counter 19, an RS-FF 21, a pulse counter 22, an AND gate 23, an inverter 25, two tri-state buffers 75.

The quench voltage measurement circuit 73 further includes a DAC 15, a lamp counter 16, an arithmetic operation circuit 24, a median search circuit 42, a selector 74, and two drivers 76 as components that are common to these light detection units 41. The light detection device according to the present embodiment further includes a plurality of imaging pixels 46 as components that are common to these light detection units 41. Each imaging pixel 46 includes an imaging SPAD 46a and an imaging circuit 46e. The imaging circuit 46e is a circuit other than the imaging SPAD 46a in each imaging pixel 46.

In the light detection device according to the present embodiment, the components illustrated in FIG. 10A are provided inside or on the surface of the same semiconductor substrate 72. For example, both the monitoring SPAD 11 of each light detection unit 41 and the imaging SPAD 46a of each imaging pixel 46 are provided inside the semiconductor substrate 72. In this manner, the monitoring SPAD 11 and the imaging SPAD 46a can be formed with the same structure and the same shape in the same manufacturing process, and the monitoring SPAD 11 and the imaging SPAD 46a can share an SPAD bias. In this case, the monitoring SPAD 11 and the imaging SPAD 46a have substantially the same property distribution, and it is possible to expect that the quench voltage measured by the monitoring SPAD 11 is substantially the same voltage as the quench voltage generated at the imaging SPAD 46a.

The arithmetic operation circuit 24 according to the present embodiment is provided as a component common to the above plurality of light detection units 41. Therefore, the light detection device according to the present embodiment includes the selector 74 outside these light detection units 41 and includes the two tri-state buffers 75 inside each light detection unit 41.

In FIG. 10A, the above plurality of imaging pixels 46 are arranged in a two-dimensional array shape. The light detection device according to the present embodiment includes light detection units 41 in one column on the right side of these imaging pixels 46. The light detection device according to the present embodiment includes the light detection units 41 in a plurality of columns on the right side of these imaging pixels 46.

FIG. 10B is a planar view illustrating a configuration of a light detection device according to a modification example of the tenth embodiment.

The light detection device according to the modification example includes a plurality of imaging pixels 46 arranged in a two-dimensional array shape similarly to the light detection device according to the tenth embodiment. The light detection device according to the modification example further includes light detection units 41 in one column on each of the right side, the left side, the upper side, and the lower side of these imaging pixels 46, and four sides of the arrays of these imaging pixels 46 are surrounded by the light detection units 41 in the four columns.

In this manner, the light detection units 41 can be arranged in various layouts to be adjacent to the imaging pixels 46. Note that although the light detection device according to the modification example includes various components other than the light detection units 41 and the imaging pixels 46 similarly to the light detection device according to the tenth embodiment, illustration thereof is omitted in FIG. 10B. This similarly applies to each of the following drawings.

FIG. 10C is a planar view illustrating a configuration of a light detection device according to another modification example of the tenth embodiment.

The light detection device according to the modification example includes a plurality of imaging pixels 46 arranged in a two-dimensional array shape similarly to the light detection device according to the tenth embodiment. The light detection device according to the modification example further includes light detection units 41 in one column above these imaging pixels 46, and columns of the light detection units 41 are arranged in an island shape at positions away from the arrays of the imaging pixels 46. In FIG. 10C, each monitoring SPAD 11 is arranged at a position away from the arrays of the imaging pixels 46 by one pixel pitch or more.

FIG. 10C further illustrates a light source 77 and a light blocking wall 78 in the light detection device according to the modification example. The light blocking wall 78 is provided between the arrays of the imaging pixels 46 and the columns of the light detection units 41 and surrounds the four sides of the columns of the light detection units 41. The light source 77 is located inside the light blocking wall 78 along with these light detection units 41. In this manner, it is possible to cause light from the light source 77 to be incident only on the light detection units 41 out of the light detection units 41 and the imaging pixels 46. The light can cause avalanche breakdown in the monitoring SPAD 11 even when there is no illuminance at the imaging target, and this enables measurement of the quench voltage in the present modification example.

### Eleventh Embodiment

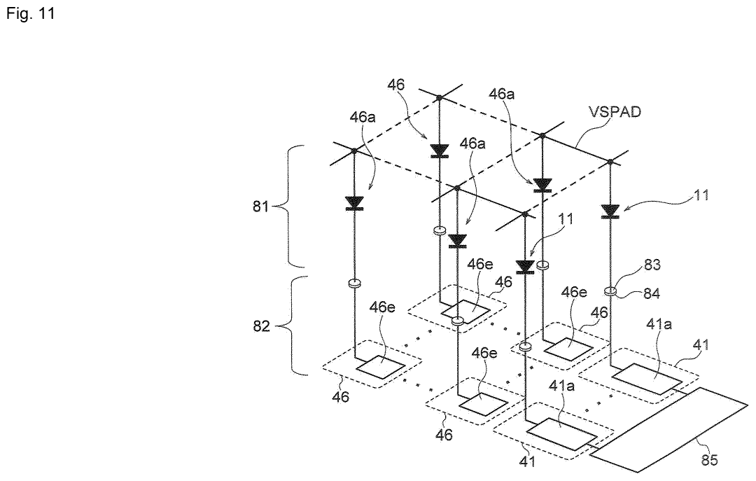

FIG. 11 is a perspective view illustrating a configuration of a light detection device according to an eleventh embodiment.

The light detection device according to the present embodiment includes a quench voltage measurement circuit 73 (see FIG. 10A), a plurality of light detection units 41 inside the quench voltage measurement circuit 73, a plurality of imaging pixels 46 outside the quench voltage measurement circuit 73, and the like similarly to the light detection device according to the tenth embodiment. The light detection device according to the present embodiment further includes a first substrate 81, a second substrate 82, a plurality of connection electrodes 83, a plurality of connection electrodes 84, and a common circuit 85. The common circuit 85 is a circuit other than the light detection units 41 inside the quench voltage measurement circuit 73.

The light detection device according to the present embodiment is manufactured by attaching the first substrate 81 to the second substrate 82. The first substrate 81 includes, for example, a semiconductor substrate and one or more layers formed on the semiconductor substrate. Similarly the second substrate 82 includes, for example, a semiconductor substrate and one or more layers formed on the semiconductor substrate. In the present embodiment, the connection electrode 83 inside the first substrate 81 is attached to the connection electrode 84 inside the second substrate 82, and the first substrate 81 is thereby electrically connected to the second substrate 82.

In each light detection unit 41, the monitoring SPAD 11 is provided inside the first substrate 81, and the light detection circuit 41a is provided inside the second substrate 82. The light detection circuit 41a is a circuit other than the monitoring SPAD 11 inside each light detection unit 41. Similarly in each imaging pixel 46, the imaging SPAD 46a is provided inside the first substrate 81, and the imaging circuit 46e is provided inside the second substrate 82.

In this manner, the light detection unit 41 and the imaging element 46 according to the present embodiment are three-dimensionally arranged in the first substrate 81 and the second substrate 82. In this manner, it is possible to accurately measure the average quench voltage Vave of the monitoring SPAD 11 and to enhance a light collection rate of the imaging SPAD 46a. Note that although the common circuit 85 according to the present embodiment is entirely arranged inside the second substrate 82, the common circuit 85 may include a part arranged inside the second substrate 82 and a part arranged inside the first substrate 81.

### Twelfth Embodiment

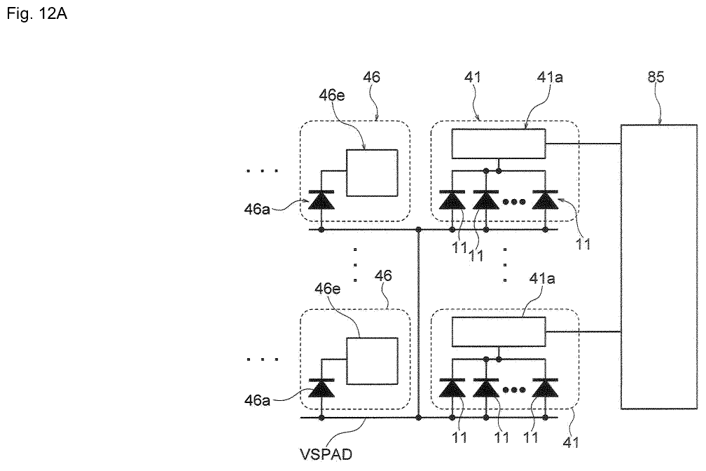

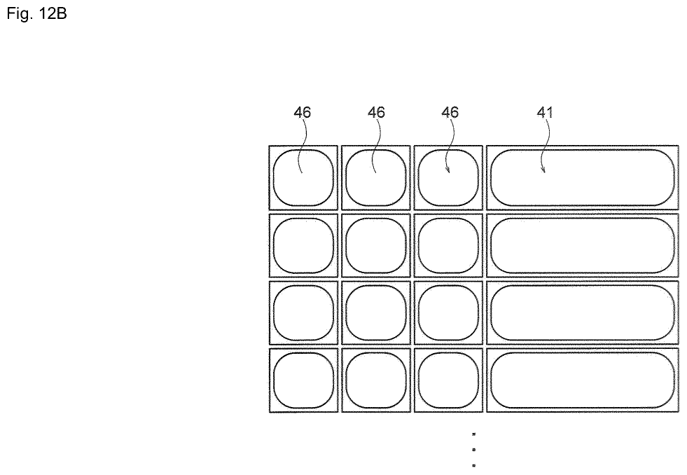

FIG. 12A is a circuit diagram illustrating a configuration of a light detection device according to a twelfth embodiment.

The light detection device according to the present embodiment includes a quench voltage measurement circuit 73 (see FIG. 10A), a plurality of light detection units 41 inside the quench voltage measurement circuit 73, a plurality of imaging pixels 46 outside the quench voltage measurement circuit 73, and the like similarly to the light detection devices according to the tenth and eleventh embodiments.

Each light detection unit 41 according to the present embodiment includes a plurality of monitoring SPADs 11 connected to each other in parallel and a light detection circuit 41a electrically connected to cathodes of these monitoring SPADs 11. Therefore, each light detection unit 41 according to the present embodiment measures the cathode voltage Vk generated by these monitoring SPADs 11. In this manner, the probability that a photon is incident on each light detection unit 41 and avalanche breakdown occurs increases, and it is possible to accurately measure the quench voltage even with low illuminance.

FIG. 12B is a planar view illustrating a configuration of a light detection device according to a modification example of the twelfth embodiment.

The light detection device according to the modification example also includes a quench voltage measurement circuit 73 (not illustrated), a plurality of light detection units 41 inside the quench voltage measurement circuit 73, a plurality of imaging pixels 46 outside the quench voltage measurement circuit 73, and the like.

In the modification example, each light detection unit 41 includes one monitoring SPAD 11, and each imaging pixel 46 includes one imaging SPAD 46a. FIG. 12B illustrates an opening of the monitoring SPAD 11 inside each light detection unit 41 with an oval and illustrates an opening of the imaging SPAD 46a inside each imaging pixel 46 with a circle. In the modification example, the opening diameter of the opening of the monitoring SPAD 11 is different from the opening diameter of the opening of the imaging SPAD 46a and is specifically larger than the opening diameter of the opening of the imaging SPAD 46a. Therefore, an active region of the monitoring SPAD 11 is larger than an active region of the imaging SPAD 46a. In this manner, the probability that a photon is incident on each light detection unit 41 and avalanche breakdown occurs increases, and it is possible to accurately measure the quench voltage even with low illuminance.

### Thirteenth Embodiment

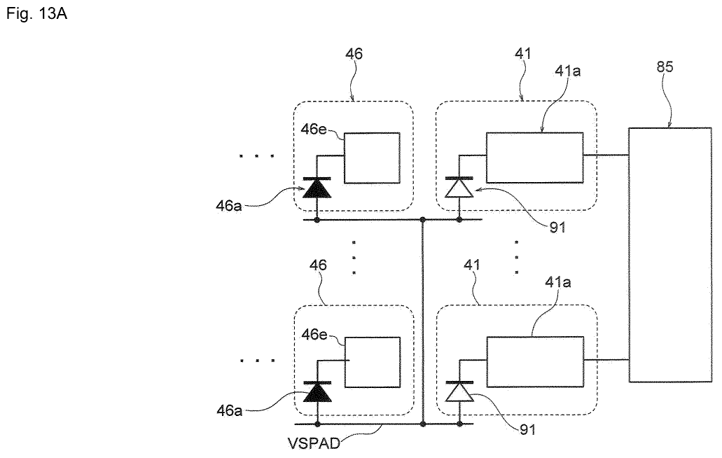

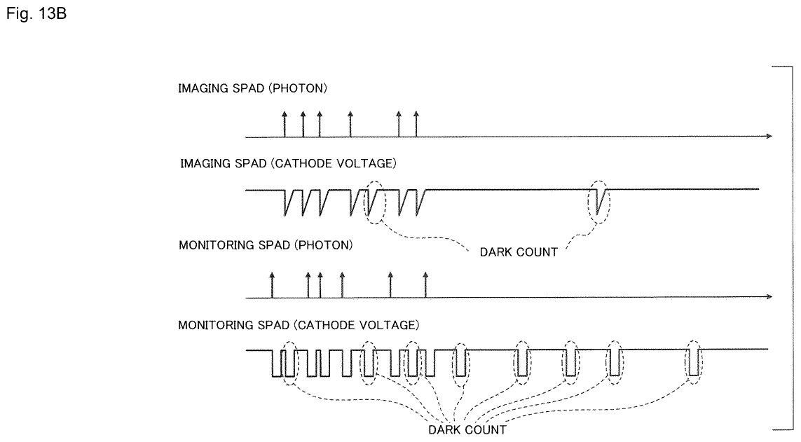

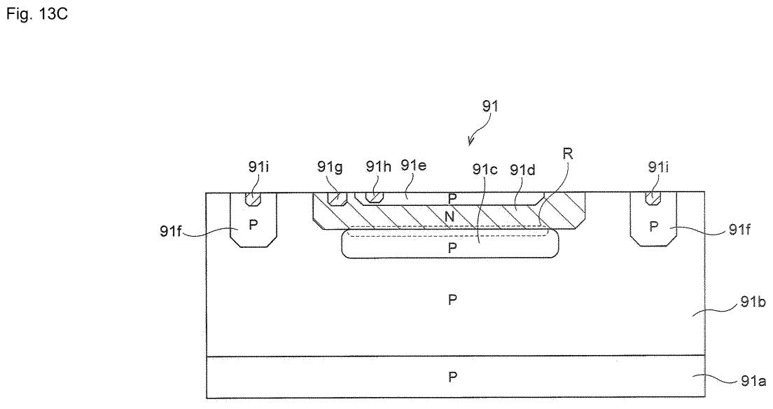

FIG. 13A is a circuit diagram illustrating a configuration of a light detection device according to a thirteenth embodiment.

The light detection device according to the present embodiment includes a quench voltage measurement circuit 73 (see FIG. 10A), a plurality of light detection units 41 inside the quench voltage measurement circuit 73, a plurality of imaging pixels 46 outside the quench voltage measurement circuit 73, and the like similarly to the light detection devices according to the tenth to twelfth embodiments.

Each light detection unit 41 according to the present embodiment includes a monitoring SPAD 91 instead of the monitoring SPAD 11. The monitoring SPAD 91 has a dark count rate that is different from that of the imaging SPAD 46a, and specifically has a dark count rate that is higher than that of the imaging SPAD 46a. The monitoring SPAD 91 is an example of the first diode according to the present disclosure similarly to the monitoring SPAD 11.

FIG. 13B is a timing chart illustrating operations of the light detection device according to the thirteenth embodiment.

FIG. 13B illustrates a timing at which a photon is incident on the imaging SPAD 46a, a change in cathode voltage of the imaging SPAD 46a, a timing at which a photon is incident on the monitoring SPAD 91, and a change in cathode voltage Vk of the monitoring SPAD 91.

The dark count rate is a rate at which avalanche breakdown occurs even if no photon is incident on the SPAD. The imaging SPAD 46a according to the present embodiment has a low dark count rate (several tens of Hz, for example) to acquire a satisfactory video. Therefore, substantially no avalanche breakdown occurs in the imaging SPAD 46a when there is no illuminance at all in the imaging target.

On the other hand, the monitoring SPAD 91 according to the present embodiment has a higher dark count rate than that of the imaging SPAD 46a. Therefore, avalanche breakdown frequently occurs in the monitoring SPAD 91 even when there is no illuminance of the imaging target at all or the illuminance is significantly low. In this manner, it is possible to measure the quench voltage in a time during which the quench voltage of the monitoring SPAD 91 is significant and to appropriately control the SPAD bias.

In order to have the same quench voltage at the monitoring SPAD 91 and the imaging SPAD 46a sharing the SPAD bias, it is necessary to have an equal breakdown voltage for both of them. Therefore, it is necessary to reduce differences between structures and shapes of the monitoring SPAD 91 and the imaging SPAD 46a even in a case where the dark count rate of the monitoring SPAD 91 is increased. Therefore, there is a case where the dark count rate of the monitoring SPAD 91 cannot be increased that much (several tens of kHz, for example). However, the measurement of the quench voltage in the present embodiment is performed by using the digital signals P and Q, and it is thus possible to accurately measure the quench voltage even at such a low dark count rate.

FIG. 13C is a sectional view illustrating a structure of the monitoring SPAD 91 according to the thirteenth embodiment.

The monitoring SPAD 91 according to the present embodiment is formed inside a semiconductor substrate 91a. Specifically, the monitoring SPAD 91 according to the present embodiment is formed of an epitaxial layer 91b inside the semiconductor substrate 91a, a semiconductor layer 91c, a semiconductor layer 91d, a semiconductor layer 91e, two semiconductor layers 91f, a contact layer 91g, an electrode 91h two contact layers 91i, and the like. For example, the semiconductor substrate 91a is a P-type substrate, the epitaxial layer 91b, the semiconductor layer 91c, the semiconductor layer 91e, and the semiconductor layer 91f are P-type regions, and the semiconductor layer 91d is an N-type region.

The epitaxial layer 91b is formed near the upper surface of the semiconductor substrate 91a inside the semiconductor substrate 91a. The semiconductor layer 91c is formed on the epitaxial layer 91b. The semiconductor layer 91d is formed on the semiconductor layer 91c. The semiconductor layer 91e is formed on the semiconductor layer 91d. The above two semiconductor layers 91f are formed to sandwich the semiconductor layers 91c, 91d, and 91e. The semiconductor layer 91e according to the present embodiment is formed to overlap an avalanche amplification region (active region) R between the semiconductor layer 91d and the semiconductor layer 91c as much as possible.

The contact layer 91g is formed on the semiconductor layer 91d. The electrode 91h is formed on the semiconductor layer 91e. Each contact layer 91i is formed on the corresponding semiconductor layer 91f. In FIG. 13C, a plurality of electrodes 91h may be formed on the semiconductor layer 91e.

In the present embodiment, a peak value of the dopant concentration inside the semiconductor layer 91e is set to be higher than the peak value of the dopant concentration inside the semiconductor layer 91d. Moreover, the semiconductor layer 91e is formed to be thin on the semiconductor layer 91d.

In the present embodiment, a silicon oxide film, which is not illustrated, is formed on the semiconductor layer 91e. An electrostatic potential field toward the depth direction depending on the types of impurities to be injected is formed by a segregation effect at an interface between the semiconductor layer 91e and the silicon oxide film. n-type impurities such as arsenic and phosphorous generate an electric field causing carrier drift toward the downward direction. On the other hand, since carrier generation/recombination centers are present at high density at the interface between the semiconductor layer 91e and the silicon oxide film, thermally generated unnecessary carriers may reach the avalanche amplification region R of the monitoring SPAD 91, which may lead to an increase in dark count.

Functions of the semiconductor layer 91e are separating the SPAD avalanche amplification region R from such surface generated carriers and improving noise performance of the light detection device. Abias voltage applied to the semiconductor layer 91e via an electrode 91h is preferably set to be equal to a bias of the semiconductor layer 91d by short-circuiting the contact layer 91g and the electrode 91h, for example. Also, a relative bias between the semiconductor layer 91e and the semiconductor layer 91d is statically or dynamically modulated, and the shape and the thickness of a depletion layer formed between these layers are intentionally controlled. For example, an ability of collecting a small number of carriers is increased or decreased with this bias. It is possible to set the dark count rate of the monitoring SPAD 91 to be higher than that of the imaging SPAD 46a through adjustment of the bias potential and with the shape of the semiconductor layer 91e.

Note that in a case where the light detection device according to the present embodiment includes light detection units 41 including the monitoring SPADs 91 and light detection units 41 including the monitoring SPADs 11, it is desirable that these light detection units 41 be arranged to be far from each other. For example, it is desirable that these light detection units 41 be arranged to be separated from each other by a distance that is equal to or greater than the width of one light detection unit 41. It is thus possible to reduce an influence of gushing out of electrons. Also, it is desirable to employ the parallel arrangement as in the twelfth embodiment or a light blocking structure as in the fourteenth embodiment, which will be described later, for the monitoring SPAD 91 according to the present embodiment.

According to the present embodiment, it is possible to AD convert the quench voltage by the avalanche breakdown of the dark count even in a no-light state where there is no image plane illuminance at all or in a state which is close to the no-light state. Also, according to the present embodiment, it is possible to appropriately control the SPAD bias for preparing for recovery of the image plane illuminance and taking of a significant image, by employing a feedback configuration similar to that in the fourth embodiment.

### Fourteenth Embodiment

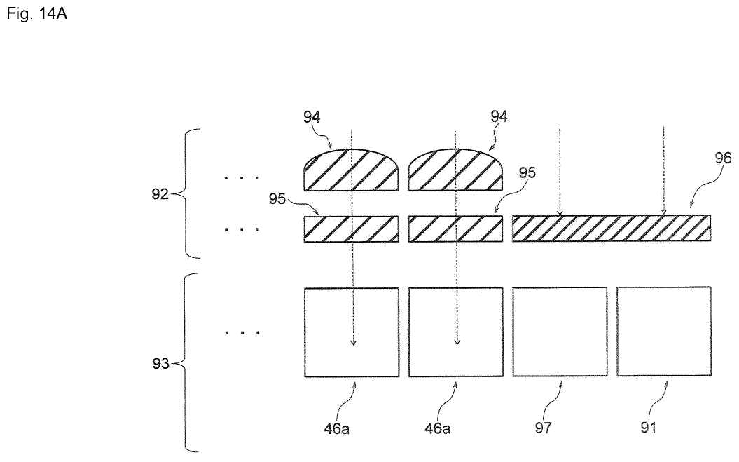

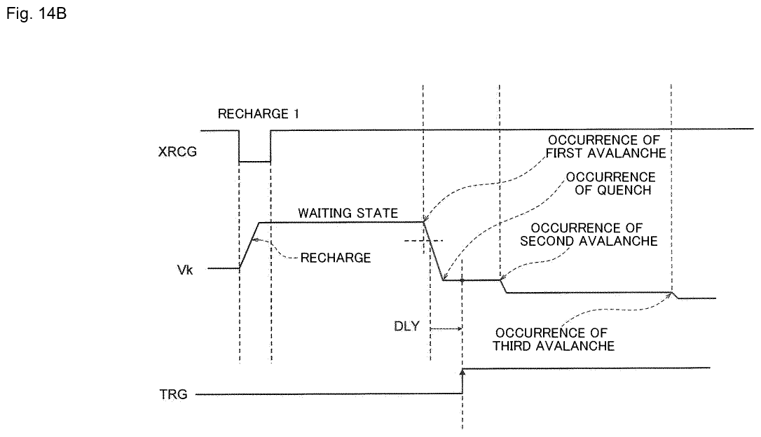

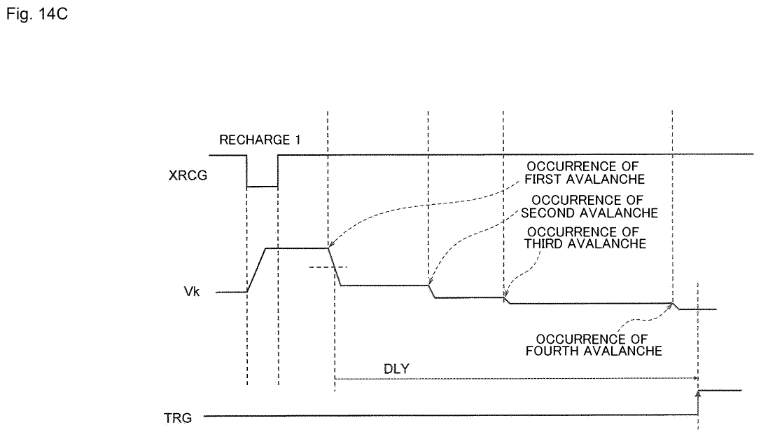

FIG. 14A is a sectional view schematically illustrating a configuration of a light detection device according to a fourteenth embodiment.

The light detection device according to the present embodiment includes a monitoring SPAD 91 inside each light detection unit 41 and an imaging SPAD 46a inside each imaging pixel 46 similarly to the light detection device according to the thirteenth embodiment. FIG. 14A illustrates one monitoring SPAD 91 and two imaging SPADs 46a in an example. The monitoring SPAD 91 has a dark count rate that is different from that of the imaging SPAD 46a, and specifically has a dark count rate that is higher than that of the imaging SPAD 46a.

The light detection device according to the present embodiment includes an optical component layer 92 and a semiconductor layer 93 as illustrated in FIG. 14A. The semiconductor layer 93 is, for example, a semiconductor substrate. The optical component layer 92 is, for example, a layer formed on the semiconductor substrate. The optical component layer 92 includes a plurality of on-chip lenses 94, a plurality of color filters 95, a light blocking plate 96, and a dummy SPAD 97. The light blocking plate 96 is an example of the light blocking unit according to the present disclosure.

FIG. 14A illustrates light advancing toward the imaging SPAD 46a, the dummy SPAD 97, and the monitoring SPAD 91 with arrows. The light directed to the imaging SPAD 46a is incident on the imaging SPAD 46a via the on-chip lens 94 and the color filter 95. On the other hand, the light directed to the dummy SPAD 97 and the monitoring SPAD 91 is reflected by the light blocking plate 96 and is not incident on the dummy SPAD 97 and the monitoring SPAD 91. In this manner, the light blocking plate 96 according to the present embodiment blocks the dummy SPAD 97 and the monitoring SPAD 91 from the light directed to the dummy SPAD 97 and the monitoring SPAD 91. In this manner, it is possible to appropriately measure the average quench voltage Vave using the monitoring SPAD 91 by using the dark count.

Also, the dummy SPAD 97 according to the present embodiment is provided between the imaging SPAD 46a and the monitoring SPAD 91. The dummy SPAD 97 is an SPAD that is a dummy and is not used as the imaging SPAD 46 and the monitoring SPAD 91. According to the present embodiment, it is possible to use the dummy SPAD 97 like the light blocking plate 96, for example, by providing the dummy SPAD 97 between the imaging SPAD 46a and the monitoring SPAD 91.

The quench voltage in the present embodiment is measured on the basis of avalanche breakdown caused at a unique dark count rate that the monitoring SPAD 91 has as an average frequency regardless of the illuminance of the imaging plane. Unlike the photon count rate that changes depending on unknown illuminance, the dark count rate can be narrowed down to a range to some extent by managing the manufacturing process of the monitoring SPAD 91. In the present embodiment, it is possible to cause avalanche breakdown once or more at a high probability in the recharge cycle by setting the recharge cycle to be sufficiently longer than the reciprocal of the dark count rate. It is thus possible to appropriately take the comparison result signal Vcm between the cathode voltage Vk (quench voltage) and the reference voltage Vref in the D-FF 18.

FIGS. 14B and 14C are timing charts illustrating operations of the light detection device according to the fourteenth embodiment.

There may be a case where avalanche breakdown occurs again in the monitoring SPAD 91 that has caused quench once and lost an excessive voltage. In this case, comparing the quench voltage that has further decreased due to the following avalanche with the reference voltage Vref corresponds to selecting and extracting only the lowest quench voltage in the avalanche that has occurred a plurality of times. Therefore, it is not possible to measure an average value of the quench voltages that are randomly distributed.

FIG. 14B is a timing chart in a case where the delay time until the comparison result signal Vcm is taken by the D-FF 18 after occurrence of avalanche breakdown is detected is taken to be sufficiently shorter than the reciprocal of the dark count rate. In this case, the quench voltage generated due to the initial avalanche breakdown after the recharge is compared with the reference voltage Vref. It is possible to accurately measure the average quench voltage Vave by repeating such comparison.

FIG. 14C is a timing chart in a case where the delay time until the comparison result signal Vcm is taken by the D-FF 18 after the occurrence of avalanche breakdown is detected is taken to be sufficiently longer than the reciprocal of the dark count rate. In this case, avalanche occurs a plurality of times within the delay time, and the lowest quench voltage among the plurality of quench voltages is compared with the reference voltage Vref. In this manner, a significantly low quench voltage that is rarely generated is compared with the reference voltage Vref. As a result, it is possible to perform measurement that is effective to control the SPAD bias such that the worst quench voltage does not exceed the element breakdown voltage of the pixel circuit.

### Application Examples

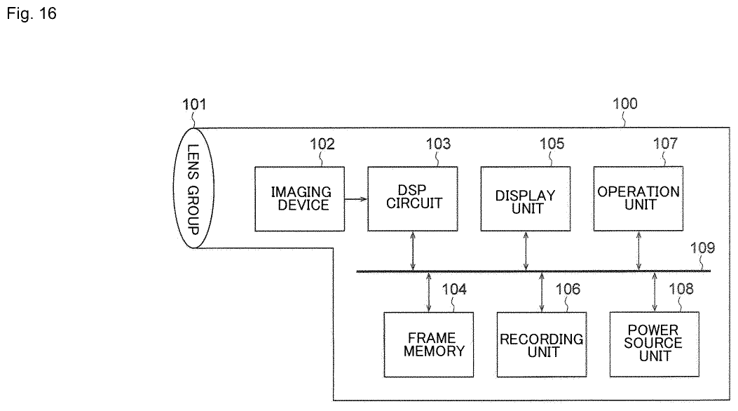

FIG. 16 is a block diagram showing a configuration example of an electronic device. The electrical device shown in FIG. 16 is a camera 100.

The camera 100 includes an optical unit 101 including a lens group and the like, the imaging device 102 which is a light detection device of any of the first to fourteenth embodiments, a digital signal processor (DSP) circuit 103 which is a camera signal processing circuit, a frame memory 104, a display unit 105, a recording unit 106, an operation unit 107, and a power supply unit 108. In addition, the DSP circuit 103, the frame memory 104, the display unit 105, the recording unit 106, the operation unit 107, and the power supply unit 108 are connected to each other via a bus line 109.

The optical unit 101 captures incident light (image light) from a subject and forms an image on an image forming surface of the imaging device 102. The imaging device 102 converts a light intensity of the incident light imaged on the image forming surface by the optical unit 101 into an electrical signal in pixel units and outputs it as a pixel signal.

The DSP circuit 103 performs signal processing on the pixel signal output by the imaging device 102. The frame memory 104 is a memory for storing one screen of a moving image or still image captured by the imaging device 102.

The display unit 105 includes, for example, a panel type display device such as a liquid crystal panel or an organic EL panel, and displays the moving image or the still image captured by the imaging device 102. The recording unit 106 records the moving image or the still image captured by the imaging device 102 in a recording medium such as a hard disk or a semiconductor memory.

The operation unit 107 issues operation commands for various functions of the camera 100 under the operation of the user. The power supply unit 108 appropriately supplies various power supplies that serve as operation power supplies for the DSP circuit 103, the frame memory 104, the display unit 105, the recording unit 106, and the operation unit 107 to these supply targets.

Acquisition of a favorable image can be expected by using the light detection device of any of the first to fourteenth embodiments as the imaging device 102.

The solid-state imaging device can be applied to various other products. For example, the solid-state imaging device may be mounted in various moving objects such as automobiles, electric vehicles, hybrid electric vehicles, motorcycles, bicycles, personal mobilities, airplanes, drones, ships, and robots.

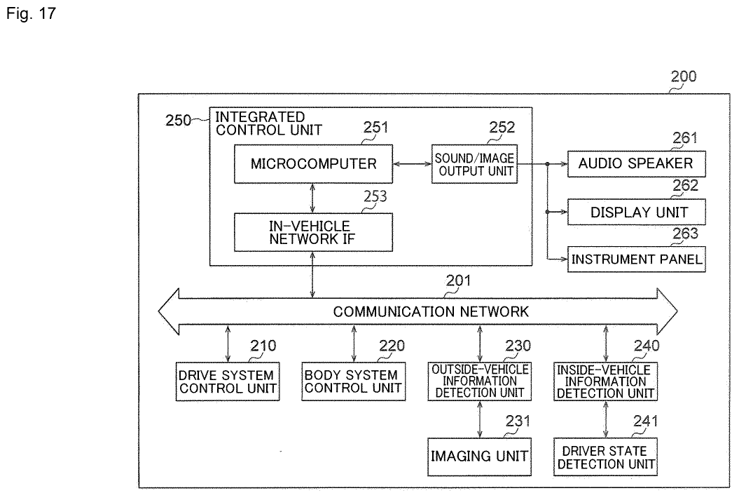

FIG. 17 is a block diagram showing a configuration example of a mobile control system. The mobile control system shown in FIG. 17 is a vehicle control system 200.

The vehicle control system 200 includes a plurality of electronic control units connected to each other via a communication network 201. In the example illustrated in FIG. 17, the vehicle control system 200 includes a drive system control unit 210, a body system control unit 220, an outside-vehicle information detection unit 230, an inside-vehicle information detection unit 240, and an integrated control unit 250. As configuration units of the integrated control unit 250, a microcomputer 251, a sound/image output unit 252, and an in-vehicle network interface (I/F) 253 are further illustrated in FIG. 17.

The drive system control unit 210 controls the operation of the device related to the drive system of the vehicle according to various programs. For example, the drive system control unit 210 functions as a control device such as a driving force generating device for generating a driving force of a vehicle such as an internal combustion engine or a drive motor, a driving force transmission mechanism for transmitting a driving force to wheels, a steering mechanism for adjusting a steering angle of a vehicle, and a braking device for generating a braking force of a vehicle.

The body system control unit 220 controls operations of various devices mounted in a vehicle body in accordance with various programs. For example, the body system control unit 220 functions as a control device for a smart key system, a keyless entry system, a power window device, various lamps (for example, a head lamp, a rear lamp, break lamps, indicators, and fog lamps), and the like. In this case, radio waves transmitted from a portable device that substitutes for a key or signals of various switches may be input to the body system control unit 220. The body system control unit 220 receives such a radio wave or signal input and controls a door lock device, a power window device, and a lamp of the vehicle.

The outside-vehicle information detection unit 230 detects information on the outside of the vehicle having the vehicle control system 200 mounted thereon. For example, an imaging unit 231 is connected to the outside-vehicle information detection unit 230. The outside-vehicle information detection unit 230 causes the imaging unit 231 to capture an image of the outside of the vehicle and receives the captured image from the imaging unit 231. The outside-vehicle information detection unit 230 may perform object detection processing or distance detection processing for peoples, cars, obstacles, signs, and letters on the road based on the received image.

The imaging unit 231 is an optical sensor that receives light and outputs an electrical signal according to the amount of the received light. The imaging unit 231 can also output the electrical signal as an image or distance measurement information. The light received by the imaging unit 231 may be visible light or invisible light such as infrared rays. The imaging unit 231 includes the light detection device of any of the first to fourteenth embodiments.

The inside-vehicle information detection unit 240 detects information inside the vehicle in which the vehicle control system 200 is mounted. For example, a driver state detection unit 241 that detects the driver's status is connected to the inside-vehicle information detection unit 240. For example, the driver state detection unit 241 includes a camera that images the driver, and the inside-vehicle information detection unit 240 may calculate the degree of fatigue or degree of concentration of the driver based on the detection information input from the driver state detection unit 241, and may determine whether the driver is asleep. The camera may include the light detection device of any of the first to fourteenth embodiments, and may be, for example, the camera 100 illustrated in FIG. 16.

The microcomputer 251 can calculate a control target value of a drive force generation device, the steering mechanism, or the braking device on the basis of information inside and outside the vehicle acquired by the outside-vehicle information detection unit 230 or the inside-vehicle information detection unit 240, and output a control command to the drive system control unit 210. For example, the microcomputer 251 can perform cooperative control for the purpose of realizing functions of an advanced driver assistance system (ADAS) including vehicle collision avoidance, impact mitigation, following traveling based on an inter-vehicle distance, vehicle speed maintenance driving, collision warning, lane deviation warning, and the like.

In addition, the microcomputer 251 can perform cooperative control for automatic driving in which autonomous driving is performed without the operation of the driver by controlling the driving force generating device, the steering mechanism or the braking device based on information around the vehicle acquired by the outside-vehicle information detection unit 230 or the inside-vehicle information detection unit 240.

In addition, the microcomputer 251 can output a control command to the body system control unit 220 based on the information acquired by the outside-vehicle information detection unit 230 outside the vehicle. For example, the microcomputer 251 can perform cooperative control for antiglare such as switching a high beam to a low beam by controlling a headlamp according to a position of a preceding vehicle or an oncoming vehicle detected by the outside-vehicle information detection unit 230.

The sound/image output unit 252 transmits an output signal of at least one of audio and an image to an output device that can visually or audibly notify the passenger of the vehicle or the outside of information. In the example shown in FIG. 17, as such an output device, an audio speaker 261, a display unit 262, and an instrument panel 263 are shown. The display unit 262 may include, for example, an onboard display or a head-up display.

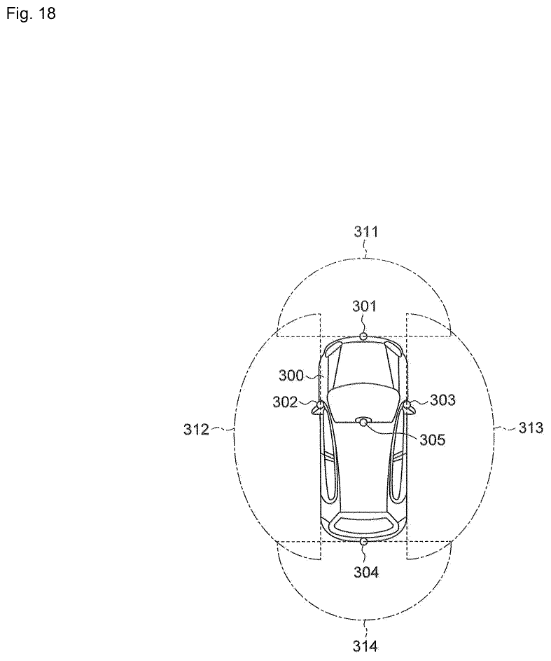

FIG. 18 is a plan view showing a specific example of setting positions of the imaging unit 231 in FIG. 17.

A vehicle 300 shown in FIG. 18 includes imaging units 301, 302, 303, 304, and 305 as the imaging unit 231. The imaging units 301, 302, 303, 304, and 305 are provided at positions, for example, the front nose, side mirrors, rear bumpers, back doors, and the upper part of the windshield in the cabin of the vehicle 300.

The imaging unit 301 provided in the front nose mainly acquires an image of the front of the vehicle 300. The imaging unit 302 provided in the left side mirror and the imaging unit 303 provided in the right side mirror mainly acquire an image of the side of the vehicle 300. The imaging unit 304 provided in the rear bumper or the back door mainly acquires an image of the rear of the vehicle 300. The imaging unit 305 provided in the upper part of the windshield in the cabin mainly acquires an image to the front of the vehicle 300. The imaging unit 305 is used for detecting, for example, preceding vehicles, pedestrians, obstacles, traffic lights, traffic signs, and lanes.

FIG. 18 shows an example of imaging ranges of the imaging units 301, 302, 303, and 304 (hereinafter referred to as “imaging units 301 to 304”). An imaging range 311 indicates an imaging range of the imaging unit 301 provided in the front nose. An imaging range 312 indicates an imaging range of the imaging unit 302 provided in the left side mirror. An imaging range 313 indicates an imaging range of the imaging unit 303 provided in the right side mirror. An imaging range 314 indicates an imaging range of the imaging unit 304 provided in the rear bumper or the back door. For example, a bird's-eye view image of the vehicle 300 from above can be obtained by superimposing image data captured by the imaging units 301 to 304. Hereinafter, the imaging ranges 311, 312, 313, and 314 will be referred to as “imaging ranges 311 to 314”.

At least one of the imaging units 301 to 304 may have a function of acquiring distance information. For example, at least one of the imaging units 301 to 304 may be a stereo camera including a plurality of imaging devices or an imaging device having pixels for phase difference detection.

For example, the microcomputer 251 (FIG. 17) calculates the distance to each three-dimensional object within the imaging ranges 311 to 314 and a temporal change in distance (the relative speed with respect to the vehicle 300) on the basis of the distance information obtained from the imaging units 301 to 304. The microcomputer 251 can extract, as a preceding car, a three-dimensional object that is located closest on the road along which the vehicle 300 advances and travels at a predetermined speed (equal to or greater than 0 km/h, for example) in substantially the same direction as that of the vehicle 300 on the basis of these calculation results. Moreover, the microcomputer 251 can set an inter-vehicle distance to be secured in advance before the preceding car and perform automatic braking control (including following stop control), automatic acceleration control (including following start control), and the like. In this manner, according to this example, it is possible to perform cooperative control for automatic driving in which autonomous driving is performed without the operation of the driver.

For example, based on the distance information obtained from the imaging units 301 to 304, the microcomputer 251 classifies the three-dimensional object data related to the three-dimensional object as a two-wheeled vehicle, an ordinary vehicle, a large vehicle, a pedestrian, a utility pole, or another three-dimensional object and performs extraction, and can use the result for automatic avoidance of an obstacle. For example, the microcomputer 251 distinguishes obstacles around the vehicle 300 as obstacles that the driver of the vehicle 300 can visually recognize and obstacles that are difficult for the driver to visually recognize. Then, the microcomputer 251 can determine a risk of collision indicating the degree of risk of collision with each obstacle and can perform driving assistance for collision avoidance by outputting a warning to the driver through the audio speaker 261 or the display unit 262 and performing forced deceleration or avoidance steering through the drive system control unit 210 when the risk of collision has a value equal to or greater than a set value and there is a possibility of collision.

At least one of the imaging units 301 to 304 may be an infrared camera that detects infrared rays. For example, the microcomputer 251 can recognize a pedestrian by determining whether there is a pedestrian in the captured images of the imaging units 301 to 304. Such pedestrian recognition is performed by, for example, a procedure in which feature points in the captured images of the imaging units 301 to 304 as infrared cameras are extracted and a procedure in which pattern matching processing is performed on a series of feature points indicating the outline of the object and it is determined whether the object is a pedestrian. When the microcomputer 251 determines that there is a pedestrian in the captured images of the imaging units 301 to 304 and the pedestrian is recognized, the sound/image output unit 252 controls the display unit 262 so that the recognized pedestrian is superimposed and displayed with a square contour line for emphasis. Further, the sound/image output unit 252 may control the display unit 262 such that an icon or the like indicating the pedestrian is displayed at a desired position.

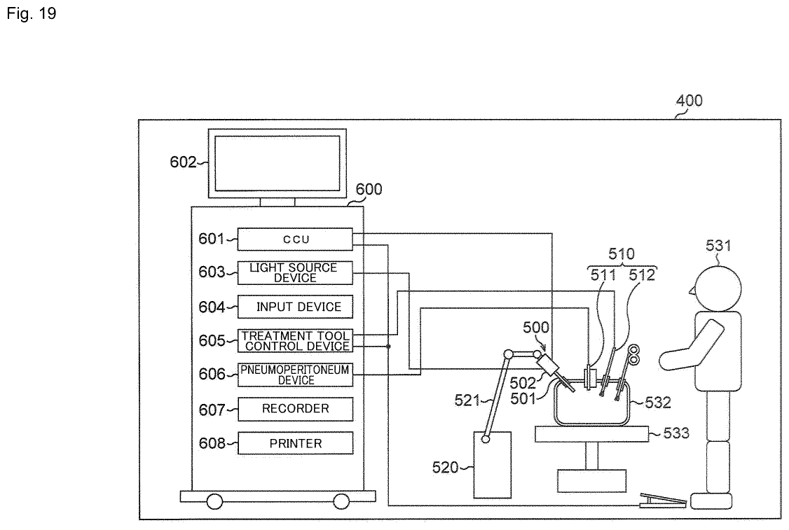

FIG. 19 is a diagram illustrating an example of a schematic configuration of an endoscopic surgery system to which the technology according to the present disclosure (the present technology) is applied.

FIG. 19 shows a state where an operator (doctor) 531 is using an endoscopic surgery system 400 to perform a surgical operation on a patient 532 on a patient bed 533. As illustrated, the endoscopic surgery system 400 is constituted of an endoscope 500, another surgical instrument 510 such as a pneumoperitoneum tube 511 or an energy treatment tool 512, a support arm apparatus 520 that supports the endoscope 500, and a cart 600 mounted with various apparatuses for endoscopic surgery.

The endoscope 500 includes a lens barrel 501 of which a region having a predetermined length from a tip thereof is inserted into a body cavity of the patient 532, and a camera head 502 connected to a base end of the lens barrel 501. In the illustrated example, the endoscope 500 configured as a so-called rigid endoscope having the rigid lens barrel 501 is illustrated, but the endoscope 500 may be configured as a so-called flexible endoscope having a flexible lens barrel.

The distal end of the lens barrel 501 is provided with an opening into which an objective lens is fitted. Alight source device 603 is connected to the endoscope 500, light generated by the light source device 603 is guided to the distal end of the lens barrel 501 by a light guide extended to the inside of the lens barrel, and the light is radiated toward an observation target in the body cavity of the patient 532 through the objective lens. The endoscope 500 may be a direct-viewing endoscope, an oblique-viewing endoscope, or a side-viewing endoscope.

An optical system and an imaging element are provided inside the camera head 502, and the reflected light (observation light) from the observation target converges on the imaging element by the optical system. The observation light is photoelectrically converted by the imaging element, and an electrical signal corresponding to the observation light, that is, an image signal corresponding to an observation image is generated. The image signal is transmitted to a camera control unit (CCU) 601 as RAW data.

The CCU 601 is constituted by a central processing unit (CPU), a graphics processing unit (GPU), or the like and comprehensively controls operations of the endoscope 500 and the display device 602. In addition, the CCU 601 receives an image signal from the camera head 502 and performs various kinds of image processing for displaying an image based on the image signal, for example, development processing (demosaic processing) on the image signal.

The display device 602 displays the image based on the image signal subjected to the image processing by the CCU 601 under the control of the CCU 601.

The light source device 603 is constituted of, for example, a light source such as a light emitting diode (LED) and supplies the endoscope 500 with irradiation light when a surgical site or the like is imaged.

An input device 604 is an input interface for an endoscopic surgery system 11000. The user can input various kinds of information or instructions to the endoscopic surgery system 400 via the input device 604. For example, the user inputs an instruction to change imaging conditions (a type of irradiation light, a magnification, a focal length, and the like) of the endoscope 500.

A treatment tool control device 605 controls driving of the energy treatment tool 512 for cauterization or incision of a tissue, sealing of blood vessel, or the like. A pneumoperitoneum device 606 sends a gas into the body cavity of the patient 532 via the pneumoperitoneum tube 511 in order to inflate the body cavity for the purpose of securing a field of view using the endoscope 500 and a working space of the operator. A recorder 607 is a device capable of recording various kinds of information on surgery. A printer 608 is a device capable of printing various kinds of information on surgery in various formats such as text, images, and graphs.

The light source device 603 that supplies the endoscope 500 with the radiation light for imaging the surgical site can be configured of, for example, an LED, a laser light source, or a white light source configured of a combination thereof. When a white light source is formed by a combination of RGB laser light sources, it is possible to control an output intensity and an output timing of each color (each wavelength) with high accuracy and thus the light source device 603 can adjust white balance of the captured image. Further, in this case, laser light from each of the respective RGB laser light sources is radiated to the observation target in a time division manner, and driving of the imaging element of the camera head 502 is controlled in synchronization with radiation timing such that images corresponding to respective RGB can be captured in a time division manner. According to this method, it is possible to obtain a color image without providing a color filter in the imaging element.

Further, driving of the light source device 603 may be controlled so that an intensity of output light is changed at predetermined time intervals. The driving of the imaging element of the camera head 502 is controlled in synchronization with a timing of changing the intensity of the light, and images are acquired in a time division manner and combined, such that an image having a high dynamic range without so-called blackout and whiteout can be generated.

In addition, the light source device 603 may have a configuration in which light in a predetermined wavelength band corresponding to special light observation can be supplied. In the special light observation, for example, by emitting light in a band narrower than that of radiation light (that is, white light) during normal observation using wavelength dependence of light absorption in a body tissue, so-called narrow band light observation (narrow band imaging) in which a predetermined tissue such as a blood vessel in a mucous membrane surface layer is imaged with a high contrast is performed. Alternatively, in the special light observation, fluorescence observation in which an image is obtained by fluorescence generated by emitting excitation light may be performed. The fluorescence observation can be performed by emitting excitation light to a body tissue and observing fluorescence from the body tissue (autofluorescence observation), or locally injecting a reagent such as indocyanine green (ICG) to a body tissue and emitting excitation light corresponding to a fluorescence wavelength of the reagent to the body tissue to obtain a fluorescence image. The light source device 603 may have a configuration in which narrow band light and/or excitation light corresponding to such special light observation can be supplied.

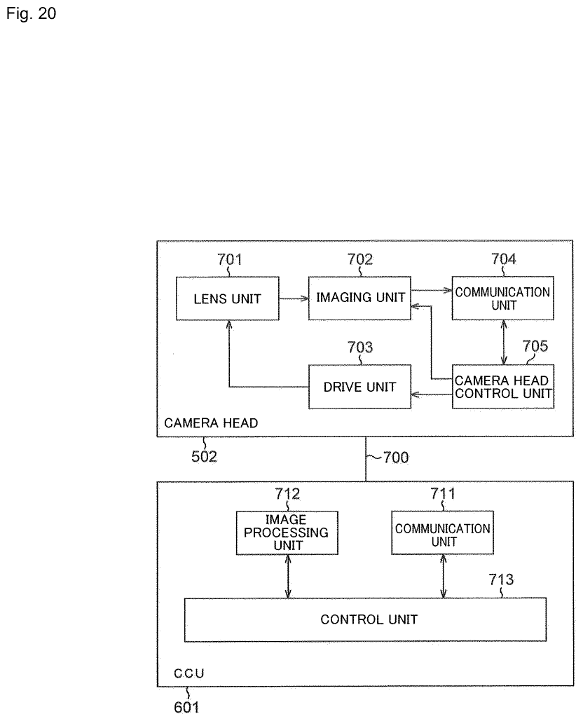

FIG. 20 is a block diagram illustrating an example of functional configurations of the camera head 502 and the CCU 601 illustrated in FIG. 19.

The camera head 502 includes a lens unit 701, an imaging unit 702, a drive unit 703, a communication unit 704, and a camera head control unit 705. The CCU 601 has a communication unit 711, an image processing unit 712, and a control unit 713. The camera head 502 and the CCU 601 are communicatively connected to each other by a transmission cable 700.

The lens unit 701 is an optical system provided in a connection portion for connection to the lens barrel 501. Observation light taken from a tip of the lens barrel 501 is guided to the camera head 502 and is incident on the lens unit 701. The lens unit 701 is configured in combination of a plurality of lenses including a zoom lens and a focus lens.

The imaging unit 702 is constituted by an imaging element. The imaging element constituting the imaging unit 702 may be one element (a so-called single plate type) or a plurality of elements (a so-called multi-plate type). When the imaging unit 702 is configured as a multi-plate type, for example, image signals corresponding to RGB are generated by the imaging elements, and a color image may be obtained by synthesizing the image signals. Alternatively the imaging unit 702 may be configured to include a pair of imaging elements for acquiring image signals for the right eye and the left eye corresponding to three-dimensional (3D) display. When 3D display is performed, the operator 531 can ascertain the depth of biological tissues in the surgical site more accurately. When the imaging unit 702 is configured in a multi-plate type, a plurality of systems of lens units 701 may be provided in correspondence to the imaging elements. The imaging unit 702 is a light detection device of any of the first to fourteenth embodiments, for example.

The imaging unit 702 need not necessarily be provided in the camera head 502. For example, the imaging unit 702 may be provided immediately after the objective lens inside the lens barrel 501.

The drive unit 703 is configured by an actuator and the zoom lens and the focus lens of the lens unit 701 are moved by a predetermined distance along an optical axis under the control of the camera head control unit 705. Accordingly the magnification and the focal point of the image captured by the imaging unit 702 can be adjusted appropriately.

The communication unit 704 is configured using a communication device for transmitting and receiving various kinds of information to and from the CCU 601. The communication unit 704 transmits the image signal obtained from the imaging unit 702 as RAW data to the CCU 601 via the transmission cable 700.

The communication unit 704 receives a control signal for controlling driving of the camera head 502 from the CCU 601 and supplies the camera head control unit 705 with the control signal. The control signal includes, for example, information on imaging condition, such as information indicating that a frame rate of the captured image is designated, information indicating that an exposure value at the time of imaging is designated, and/or information indicating that the magnification and the focal point of the captured image is designated.

Note that the imaging conditions such as the frame rate, the exposure value, the magnification, and the focal point may be appropriately designated by the user, or may be automatically set by the control unit 713 of the CCU 601 on the basis of the acquired image signal. In the latter case, a so-called auto exposure (AE) function, a so-called auto focus (AF) function, and a so-called auto white balance (AWB) function are mounted in the endoscope 500.

The camera head control unit 705 controls driving of the camera head 502 on the basis of a control signal from the CCU 601 received via the communication unit 704.

The communication unit 711 is constituted of a communication device that transmits and receives various kinds of information to and from the camera head 502. The communication unit 711 receives an image signal transmitted via the transmission cable 700 from the camera head 502.

Further, the communication unit 711 transmits the control signal for controlling the driving of the camera head 502 to the camera head 502. The image signal or the control signal can be transmitted through electric communication, optical communication, or the like.

The image processing unit 712 performs various kinds of image processing on the image signal that is the RAW data transmitted from the camera head 502.

The control unit 713 performs various kinds of control on imaging of a surgical site by the endoscope 500, display of the captured image obtained through imaging of the surgical site, and the like. For example, the control unit 713 generates a control signal for controlling driving of the camera head 502.

In addition, the control unit 713 causes the display device 602 to display a captured image showing a surgical site or the like on the basis of an image signal subjected to the image processing by the image processing unit 712. At this time, the control unit 713 may recognize various objects in the captured image using various image recognition techniques. For example, the control unit 713 can recognize a surgical instrument such as forceps, a specific biological site, bleeding, mist or the like at the time of use of the energy treatment tool 512, or the like by detecting a shape, a color, or the like of an edge of an object included in the captured image. When the display device 602 is caused to display a captured image, the control unit 713 may superimpose various kinds of surgery support information on an image of the surgical site using the recognition result. By displaying the surgery support information in a superimposed manner and presenting it to the operator 531, a burden on the operator 531 can be reduced, and the operator 531 can reliably proceed with the surgery.

The transmission cable 700 that connects the camera head 502 and the CCU 601 is an electrical signal cable compatible with communication of electrical signals, an optical fiber compatible with optical communication, or a composite cable of these.

Here, although wired communication is performed using the transmission cable 700 in the illustrated example, communication between the camera head 502 and the CCU 601 may be performed wirelessly.

While embodiments of the present disclosure have been described above, these embodiments may be implemented with various modifications without departing from the spirit of the present disclosure. For example, a combination of two or more embodiments may be implemented.

Here, the present disclosure may have the following configuration.

(1)

Alight detection device including: first diodes that receive light and output a signal voltage; a digital-to-analog converter that outputs a reference voltage in synchronization with a clock signal; a comparison circuit that compares the signal voltage with the reference voltage; a trigger circuit that outputs a trigger signal in response to the signal voltage; a flip-flop that takes an output signal from the comparison circuit in response to the trigger signal; and a first counter that outputs a digital value that changes in accordance with an average voltage at feature points of the signal voltage by counting a value of an output signal from the flip-flop in synchronization with the clock signal.

(2)

The light detection device according to (1), in which the first counter outputs the digital value that changes in accordance with the average voltage at the feature points of the signal voltage by incrementing a count value in a case where a value of the output signal from the flip-flop is 1 at an edge of the clock signal.

(3)

The light detection device according to (1), in which the feature points of the signal voltage are avalanche quenches of the signal voltage, and the first counter outputs the digital value that changes in accordance with an average value of quench voltages of the signal voltage.

(4)

The light detection device according to (1), in which the first diodes are single photon avalanche diodes (SPADs).

(5)

The light detection device according to (1), in which the digital-to-analog converter sweeps the reference voltage by increasing the reference voltage in a stepwise manner.

(6)

The light detection device according to (1), in which the trigger circuit includes a pulse detection circuit including an inverter that receives the signal voltage and a delay circuit that generates the trigger signal by delaying an output signal from the pulse detection circuit.

(7)

The light detection device according to (1), further including: a recharge transistor that is electrically connected to the first diodes, the comparison circuit, and the trigger circuit; and a second counter that controls the digital-to-analog converter in synchronization with the clock signal.

(8)

The light detection device according to (1), further including: a third counter that counts the number of clock cycles at which the feature points of the signal voltage are detected; and an arithmetic operation circuit that calculates the average voltage at the feature points of the signal voltage by using the digital value and the number of clock cycles.

(9)

The light detection device according to (1), in which the comparison circuit includes a first source follower that receives the signal voltage, a second source follower that receives the reference voltage, and a comparator that compares an output voltage from the first source follower with an output voltage from the second source follower.

(10)

The light detection device according to (1), further including: a feedback circuit that feedbacks a signal generated in accordance with the digital value to the first diodes.

(11)

The light detection device according to (1), further including: a correction circuit that performs photon detection efficiency (PDE) correction in accordance with the digital value.

(12)

The light detection device according to (1), in which the digital-to-analog converter sweeps the reference voltage by increasing the reference voltage in a stepwise manner at a proportion of once in a plurality of clock cycles.

(13)

The light detection device according to (1), in which the digital-to-analog converter sweeps the reference voltage by increasing and decreasing the reference voltage in a stepwise manner.

(14)

The light detection device according to (1), in which the digital-to-analog converter updates a value of the reference voltage by a pseudo random number that changes in synchronization with the clock signal.

(15)

The light detection device according to (1), further including: second diodes that are provided in a semiconductor substrate including the first diodes and are used for image capturing.

(16)

The light detection device according to (15), in which the first diodes are disposed at positions separated from a pixel array including the second diodes by one pixel pitch or more.

(17)

The light detection device according to (1), further including: a first substrate including the first diodes; and a second substrate that is attached to the first substrate.

(18)

The light detection device according to (1), in which the signal voltage is generated by the plurality of first diodes that are connected to each other in parallel.

(19)

The light detection device according to (1), in which an active region of the first diodes is larger than an active region of a second diodes used for image capturing.

(20)

The light detection device according to (1), further including: second diodes that have a dark count rate that is different from that of the first diodes and are used for image capturing.

(21)

The light detection device according to (20), further including: a light blocking unit that blocks the first diodes from light directed to the first diodes.

(22)

The light detection device according to (21), in which a reciprocal of a dark count rate of the first diodes is set to be shorter than a delay until an output signal from the comparison circuit is taken in response to the trigger signal.

(23)

Alight detection device including: first diodes that receive light and output a signal voltage; a digital-to-analog converter that outputs a reference voltage; a comparison circuit that compares the signal voltage with the reference voltage; a trigger circuit that outputs a trigger signal in response to the signal voltage; a flip-flop that takes an output signal from the comparison circuit in response to the trigger signal; and a state machine that outputs a signal to cause the digital-to-analog converter to update the reference voltage and outputs an average voltage at feature points of the signal voltage in response to an output signal from the flip-flop.

### REFERENCE SIGNS LIST

1 Light detection unit
1a Timing detection circuit
1b Buffer
1c Sample hold circuit
2 Inter-pixel average acquisition unit
3 Time average acquisition unit
4 ADC
11 Monitoring SPAD
12 Recharge transistor
13 Pulse detection circuit
14 Comparison circuit
15 DAC
16 Lamp counter
17 Delay circuit
18 D-FF
19 Comparison result counter
21 RS-FF
22 Pulse counter
23 AND gate
24 Arithmetic operation circuit
25 Inverter
31 Source follower transistor
32 Clamp transistor
33 Constant current source
34 Clamp transistor
35 Source follower transistor
36 Constant current source
37 Comparator
41 Light detection unit
41a Light detection circuit
42 Median search circuit
43 Digital filter
44 Target voltage value register
45 Power IC
46 Imaging pixel
46a Imaging SPAD
46b Correction coefficient multiplier
46c Imaging counter
46d Inverter
46e Imaging circuit
47 PDE correction table
48 Thermometer
49 Fixed power source
51 Frequency divider
52 Full adder
53 Half adder
54 D-FF
61 State machine
62 DAC
63 Rising detection circuit
64 Delay circuit
65 Timer
66 OR gate
71 MUX
72 Semiconductor substrate
73 Quench voltage measurement circuit
74 Selector
75 Tri-state buffer
76 Driver
77 Light source
78 Light blocking wall
81 First substrate
82 Second substrate
83 Connection electrode
84 Connection electrode
85 Common circuit
91 Monitoring SPAD
91a Semiconductor substrate
91b Epitaxial layer
91c Semiconductor layer
91d Semiconductor layer
91e Semiconductor layer
91f Semiconductor layer
91g Contact layer
91h Electrode
91i Contact layer
92 Optical component layer
93 Semiconductor layer
94 On-chip lens
95 Color filter
96 Light blocking plate
97 Dummy SPAD

1. Alight detection device comprising:
first diodes that receive light and output a signal voltage;
a digital-to-analog converter that outputs a reference voltage in synchronization with a clock signal;
a comparison circuit that compares the signal voltage with the reference voltage;
a trigger circuit that outputs a trigger signal in response to the signal voltage;
a flip-flop that takes an output signal from the comparison circuit in response to the trigger signal; and
a first counter that outputs a digital value that changes in accordance with an average voltage at feature points of the signal voltage by counting a value of an output signal from the flip-flop in synchronization with the clock signal.

2. The light detection device according to claim 1, wherein the first counter outputs the digital value that changes in accordance with the average voltage at the feature points of the signal voltage by incrementing a count value in a case where a value of the output signal from the flip-flop is 1 at an edge of the clock signal.

3. The light detection device according to claim 1, wherein the feature points of the signal voltage are avalanche quenches of the signal voltage, and the first counter outputs the digital value that changes in accordance with an average value of quench voltages of the signal voltage.

4. The light detection device according to claim 1, wherein the first diodes are single photon avalanche diodes (SPADs).

5. The light detection device according to claim 1, wherein the digital-to-analog converter sweeps the reference voltage by increasing the reference voltage in a stepwise manner.

6. The light detection device according to claim 1, wherein the trigger circuit includes a pulse detection circuit including an inverter that receives the signal voltage and a delay circuit that generates the trigger signal by delaying an output signal from the pulse detection circuit.

7. The light detection device according to claim 1, further comprising: a recharge transistor that is electrically connected to the first diodes, the comparison circuit, and the trigger circuit; and a second counter that controls the digital-to-analog converter in synchronization with the clock signal.

8. The light detection device according to claim 1, further comprising: a third counter that counts the number of clock cycles at which the feature points of the signal voltage are detected; and an arithmetic operation circuit that calculates the average voltage at the feature points of the signal voltage by using the digital value and the number of clock cycles.

9. The light detection device according to claim 1, wherein the comparison circuit includes a first source follower that receives the signal voltage, a second source follower that receives the reference voltage, and a comparator that compares an output voltage from the first source follower with an output voltage from the second source follower.

10. The light detection device according to claim 1, further comprising: a feedback circuit that feedbacks a signal generated in accordance with the digital value to the first diodes.

11. The light detection device according to claim 1, further comprising: a correction circuit that performs photon detection efficiency (PDE) correction in accordance with the digital value.

12. The light detection device according to claim 1, wherein the digital-to-analog converter sweeps the reference voltage by increasing the reference voltage in a stepwise manner at a proportion of once in a plurality of clock cycles.

13. The light detection device according to claim 1, wherein the digital-to-analog converter sweeps the reference voltage by increasing and decreasing the reference voltage in a stepwise manner.

14. The light detection device according to claim 1, wherein the digital-to-analog converter updates a value of the reference voltage by a pseudo random number that changes in synchronization with the clock signal.

15. The light detection device according to claim 1, further comprising: second diodes that are provided in a semiconductor substrate including the first diodes and are used for image capturing.

16. The light detection device according to claim 15, wherein the first diodes are disposed at positions separated from a pixel array including the second diodes by one pixel pitch or more.

17. The light detection device according to claim 1, further comprising: a first substrate including the first diodes; and a second substrate that is attached to the first substrate.

18. The light detection device according to claim 1, wherein the signal voltage is generated by the plurality of first diodes that are connected to each other in parallel.

19. The light detection device according to claim 1, wherein an active region of the first diodes is larger than an active region of a second diodes used for image capturing.

20. The light detection device according to claim 1, further comprising: second diodes that have a dark count rate that is different from that of the first diodes and are used for image capturing.

21. The light detection device according to claim 20, further comprising: a light blocking unit that blocks the first diodes from light directed to the first diodes.

22. The light detection device according to claim 21, wherein a reciprocal of a dark count rate of the first diodes is set to be shorter than a delay until an output signal from the comparison circuit is taken in response to the trigger signal.

23. Alight detection device comprising:
first diodes that receive light and output a signal voltage;
a digital-to-analog converter that outputs a reference voltage;
a comparison circuit that compares the signal voltage with the reference voltage;
a trigger circuit that outputs a trigger signal in response to the signal voltage;
a flip-flop that takes an output signal from the comparison circuit in response to the trigger signal; and
a state machine that outputs a signal to cause the digital-to-analog converter to update the reference voltage and outputs an average voltage at feature points of the signal voltage in response to an output signal from the flip-flop.
